(19) United States
(12) Patent Application Publication
(10) Pub. No.: US 2014/0198126 A1
(43) Pub. Date: Jul. 17, 2014

(54) METHODS AND APPARATUS FOR REDUCED LOW-TONE HALF-TONE PATTERN VISIBILITY

(71) Applicant: QUALCOMM MEMS TECHNOLOGIES, INC., San Diego, CA (US)

(72) Inventors: Manu Parmar, Sunnyvale, CA (US); Jeho Lee, Palo Alto, CA (US)

(73) Assignee: QUALCOMM MEMS Technologies, Inc., San Diego, CA (US)

(21) Appl. No.: 13/742,872

(22) Filed: Jan. 16, 2013

(51) Int. Cl. G09G 3/20

(52) U.S. Cl. CPC G09G 3/2044
USPC 345/597; 345/596

(57) ABSTRACT

This disclosure provides methods, apparatus, and computer programs encoded on computer storage media for reduced low tone pattern visibility. In one aspect, the disclosed methods receive an input image including a plurality of pixels, quantize the plurality of pixels, set half-tone image pixels corresponding to the portion of the input pixels that are below a crush threshold to a crushed value, and diffuse the quantization error resulting from the quantizing to half-tone image pixels other than the portion. In some implementations, the half-tone image pixels are then output to an output device such as an electronic display.

### TECHNICAL FIELD

This disclosure relates to half-toning methods and apparatus for electronic displays, for example, a display that includes interferometric modulators.

### DESCRIPTION OF THE RELATED TECHNOLOGY

Electromechanical systems (EMS) include devices having electrical and mechanical elements, actuators, transducers, sensors, optical components (e.g., mirrors) and electronics. Electromechanical systems can be manufactured at a variety of scales including, but not limited to, microscales and nanoscales. For example, microelectromechanical systems (MEMS) devices can include structures having sizes ranging from about a micron to hundreds of microns or more. Nanoelectromechanical systems (NEMS) devices can include structures having sizes smaller than a micron including, for example, sizes smaller than several hundred nanometers. Electromechanical elements may be created using deposition, etching, lithography, and/or other micromachining processes that etch away parts of substrates and/or deposited material layers, or that add layers to form electrical and electromechanical devices.

One type of electromechanical systems device is called an interferometric modulator (IMOD). As used herein, the term interferometric modulator or interferometric light modulator refers to a device that selectively absorbs and/or reflects light using the principles of optical interference. In some implementations, an interferometric modulator may include a pair of conductive plates, one or both of which may be transparent and/or reflective, wholly or in part, and capable of relative motion upon application of an appropriate electrical signal. In an implementation, one plate may include a stationary layer deposited on a substrate and the other plate may include a reflective membrane separated from the stationary layer by an air gap. The position of one plate in relation to another can change the optical interference of light incident on the interferometric modulator. Interferometric modulator devices have a wide range of applications, and are anticipated to be used in improving existing products and creating new products, especially those with display capabilities.

Digital images can be encoded as 24 bits per pixel (bpp) RGB data, which is typically considered to be of a higher bit-depth. However, many image rendering devices (e.g., printers, displays, etc.) have a lower bit-depth, such as bi-level or multi-level with only a few different color or gray levels (for black and white images) per pixel. For instance, many printers can render only 1 bit per channel (3 bpp). Some color reflective displays, for example, analog electromechanical display devices, can render 2 bits per channel (for a total of 6 bpp for three (3) channel colors). Quantizing an input image of a higher bit-depth to render the input image using a lower bit-depth device may lead to many image artifacts (banding, false color, contouring, and so on) appearing in the output image.

To reduce quantization artifacts, a process called half-toning can be used to reduce continuous-tone (or high bit-depth) images to images with a limited number of tone levels (or low bit-depth images). Half-toning is a process that can be used for creating the perception of a continuous-tone color image with a limited number of tone levels by using knowledge of the spatio-chromatic discrimination capabilities of the human visual system.

In general, half-toning methods can be grouped into three categories, namely, iterative methods, error diffusion, and mask-based dithering (or screening). Iterative methods are known to create the highest quality half-tone images among methods in the above three categories. However, they may require a great deal of computation and may be impractical for some real-time applications. Since its introduction in 1975 by Floyd and Steinberg, error diffusion methods (for example, Floyd Steinberg Error Diffusion (FSE)) have attracted much interest in the graphics community and have gained popularity to mitigate quantization issues. Some advantages of FSE include its simplicity and the resulting overall acceptable visual quality of binary images produced by the method. Mask-based dithering or screening may require the least computation among methods in the three half-toning categories.

### SUMMARY

The systems, methods and devices of the disclosure each have several innovative aspects, no single one of which is solely responsible for the desirable attributes disclosed herein.

One innovative aspect of the subject matter described in this disclosure can be implemented in a method of rendering at least a portion of a half-tone image on a display. The method includes receiving an input image including a plurality of input pixels; dithering at least a portion of the input pixels; setting half-tone image pixels corresponding to the portion of the input pixels that are below a crush threshold to a crushed value; and outputting the half-tone image pixels to an output device. In some implementations, the method further includes setting half-tone image pixels corresponding to the portion of input pixels that are above the threshold based on the dithering. In some implementations, dithering includes quantizing. In some of these implementations, dithering further includes diffusing a quantization error. In some of these implementations, the portion of input pixels below the crush threshold are quantized, and at least a portion of quantization error resulting from the quantizing is diffused to half-tone image pixels.

In some implementations, the output device is an electronic display. In some implementations, the input image is received from an input device. In some implementations, the method further includes clipping quantization error resulting from the quantizing before diffusing the quantization error. In some implementations, the dithering utilizes Floyd Steinberg Error Diffusion. In some implementations, dithering adds noise to the input pixels. In some implementations, the crush threshold is between four percent and six percent of a dynamic range of a plurality of input pixels. In some implementations, the method further includes utilizing a second crush threshold for green pixels that is lower than the crush threshold, which is used for non-green pixels. Another aspect disclosed is an electronic display displaying an image comprised of a plurality of pixel values determined based on the method of claim 1.

Another aspect disclosed is an apparatus for rendering at least a portion of a half-tone image on a display. The apparatus includes a processor, a memory operably connected to the processor, the memory configured to store: an image receiver module, configured to receive an input image including a plurality of input pixels, a dithering module, configured to dither at least a portion of the input pixels, a pixel crush module, configured to set half-tone image pixels corresponding to the portion of the input pixels that are below a crush threshold to a crushed value, and an output module, configured to output the half-tone image pixels to an output device.

In some implementations, the dithering module is further configured to set half-tone image pixels corresponding to the portion of input pixels that are above the threshold based on the dithering. In some implementations, the dithering module is further configured to quantize the portion of the input pixels. In some implementations, the dithering module is further configured to diffuse a quantization error resulting from the quantizing. In some implementations, the dithering module is further configured to diffuse at least a portion of the quantization error resulting from quantizing the portion of input pixels below the crush threshold to half-tone image pixels.

Some implementations of the apparatus further include an error clipping module, configured to clip quantization error resulting from the quantizing before diffusing the quantization error. In some implementations, the dithering module is further configured to implement Floyd Steinberg Error Diffusion for at least a portion of the input pixels. In some implementations, the dithering module is further configured to add noise to a portion of the input pixels. In some implementations, the crush threshold is between four percent and six percent of a dynamic range of a plurality of input pixels.

In some implementations, the pixel crush module is further configured to utilize a second crush threshold for green pixels that is lower than the crush threshold, wherein the crush threshold is used for non-green pixels.

Another aspect disclosed is an apparatus for rendering at least a portion of a half-tone image on a display. The apparatus includes means for receiving an input image including a plurality of input pixels, means for dithering at least a portion of the input pixels, means for setting half-tone image pixels corresponding to the portion of the input pixels that are below a crush threshold to a crushed value; and means for outputting the half-tone image pixels to an output device.

In some implementations, the apparatus further includes means for setting half-tone image pixels corresponding to the portion of input pixels that are above the threshold based on the dithering. In some implementations, the means for dithering is configured to quantize the portion of the input pixels. In some implementations, the means for dithering is further configured to diffuse a quantization error. In some implementations, the means for dithering is further configured to diffuse at least a portion of the quantization error resulting from quantizing the portion of input pixels below the crush threshold to half-tone image pixels.

In some implementations, the apparatus further includes means for clipping quantization error resulting from the quantizing before diffusing the quantization error. In some implementations, the means for dithering is further configured to utilize Floyd Steinberg Error Diffusion. In some implementations, the means for dithering is further configured to add noise to the input pixel. In some implementations, the crush threshold is between four percent and six percent of a dynamic range of a plurality of input pixels. Some implementations further include means for utilizing a second crush threshold for green pixels that is lower than the crush threshold, and wherein the crush threshold is used for non-green pixels.

Another aspect disclosed is a non-transitory, computer readable medium comprising instructions that when executed causes one or more processors to perform a method of rendering at least a portion of a half-tone image on a display. The method includes receiving an input image including a plurality of input pixels, dithering at least a portion of the input pixels, setting half-tone image pixels corresponding to the portion of the input pixels that are below a crush threshold to a crushed value, and outputting the half-tone image pixels to an output device. In some implementations, the method further comprises setting half-tone image pixels corresponding to the portion of input pixels that are above the threshold based on the dithering.

In some implementations, dithering includes quantizing the portion of the input pixels. In some implementations, dithering further includes diffusing a quantization error resulting from quantizing the input pixels.

In some implementations, at least a portion of the quantization error resulting from quantizing the portion of input pixels below the crush threshold is diffused to half-tone image pixels. In some implementations, the dithering utilizes Floyd Steinberg Error Diffusion. In some implementations, the dithering adds noise to the input pixel.

In some implementations, the crush threshold is between four percent and six percent of a dynamic range of a plurality of input pixels. In some implementations, the method further comprising includes utilizing a second crush threshold for green pixels that is lower than the crush threshold, wherein the crush threshold is used for non-green pixels.

Details of one or more implementations of the subject matter described in this specification are set forth in the accompanying drawings and the description below. Other features, aspects, and advantages will become apparent from the description, the drawings, and the claims. Note that the relative dimensions of the following figures may not be drawn to scale.

### BRIEF DESCRIPTION OF THE DRAWINGS

FIG. 1 shows an example of an isometric view depicting two adjacent pixels in a series of pixels of an interferometric modulator (IMOD) display device.

FIG. 2 shows an example of a system block diagram illustrating an electronic device incorporating a 3×3 interferometric modulator display.

FIG. 3 shows an example of a diagram illustrating movable reflective layer position versus applied voltage for the interferometric modulator of FIG. 1.

FIG. 4 shows an example of a table illustrating various states of an interferometric modulator when various common and segment voltages are applied.

FIG. 5A shows an example of a diagram illustrating a frame of display data in the 3×3 interferometric modulator display of FIG. 2.

FIG. 5B shows an example of a timing diagram for common and segment signals that may be used to write the frame of display data illustrated in FIG. 5A.

FIG. 6A shows an example of a partial cross-section of the interferometric modulator display of FIG. 1.

FIGS. 6B-6E show examples of cross-sections of varying implementations of interferometric modulators.

FIG. 7 shows an example of a flow diagram illustrating a manufacturing process for an interferometric modulator.

FIGS. 8A-8E show examples of cross-sectional schematic illustrations of various stages in a method of making an interferometric modulator.

FIG. 9A shows a half-tone pattern with a foreground level of one (1) on a background of level of two (2).

FIG. 9B shows a half-tone pattern having a similar signal-to-noise ratio (SNR) (for example, a mean and/or variance) to that of FIG. 9A, but with a foreground level of three (3) and a background level of four (4).

FIGS. 10A-B show two images that demonstrate crushing pixel values below a threshold.

FIGS. 11A-B show an example of the loss of image features in dark areas after pixels have been crushed.

FIGS. 12A-B also show a representation of a digital image before and after a process of mitigating the noisy appearance of low-tone levels has been applied to the image.

FIG. 13 is a block diagram illustrating one implementation of an apparatus for rendering an image on an electronic display.

FIG. 14 is a schematic of a flow diagram illustrating of one implementation of a method for rendering an image.

FIG. 15 is a flow diagram illustrating an example of one implementation of a method for rendering an image.

FIG. 16A is a flowchart of one implementation of a method for rendering an image.

FIG. 16B illustrates how an eight (8) bit pixel value may be quantized into two bpp using four quantization levels.

FIG. 16C illustrates sparse zones defined around each quantization level of a 2 bpp image.

FIG. 16D is a flowchart of one implementation of a method for rendering an image.

FIG. 16E is a flowchart of one implementation of a method for rendering an image.

FIG. 17 is a flowchart of one implementation of a method for rendering an image.

FIG. 18A is a flowchart of one implementation of a method for rendering an image.

FIG. 18B is a flowchart of one implementation of a method for rendering an image.

FIG. 19 shows one implementation of an error clipping scheme that supports bi-level half-toning (1 bpp output) and multi-level half-toning (2 bpp or more output).

FIGS. 20A and 20B demonstrate the improvement in a half-toned image generated by some of the disclosed implementations.

FIGS. 21A and 21B demonstrate the improvement in a half-toned image generated by some of the disclosed implementations.

FIGS. 22A and 22B demonstrate the improvement in a half-toned image generated by some of the disclosed implementations.

FIGS. 23A and 23B show examples of system block diagrams illustrating a display device 40 that includes a plurality of interferometric modulators.

Like reference numbers and designations in the various drawings indicate like elements.

### DETAILED DESCRIPTION

The following detailed description is directed to certain implementations for the purposes of describing the innovative aspects. However, the teachings herein can be applied in a multitude of different ways. The described implementations may be implemented in any device that is configured to display an image, whether in motion (e.g., video) or stationary (e.g., still image), and whether textual, graphical or pictorial. More particularly, it is contemplated that the implementations may be implemented in or associated with a variety of electronic devices such as, but not limited to, mobile telephones, multimedia Internet enabled cellular telephones, mobile television receivers, wireless devices, smartphones, Bluetooth devices, personal data assistants (PDAs), wireless electronic mail receivers, hand-held or portable computers, netbooks, notebooks, smartbooks, tablets, printers, copiers, scanners, facsimile devices, GPS receivers/navigators, cameras, MP3 players, camcorders, game consoles, wrist watches, clocks, calculators, television monitors, flat panel displays, electronic reading devices (e-readers), computer monitors, auto displays (e.g., odometer display, etc.), cockpit controls and/or displays, camera view displays (e.g., display of a rear view camera in a vehicle), electronic photographs, electronic billboards or signs, projectors, architectural structures, microwaves, refrigerators, stereo systems, cassette recorders or players, DVD players, CD players, VCRs, radios, portable memory chips, washers, dryers, washer/dryers, parking meters, packaging (such as electromechanical systems (EMS), MEMS and non-MEMS applications), aesthetic structures (e.g., display of images on a piece of jewelry) and a variety of electromechanical systems devices. The teachings herein also can be used in non-display applications such as, but not limited to, electronic switching devices, radio frequency filters, sensors, accelerometers, gyroscopes, motion-sensing devices, magnetometers, inertial components for consumer electronics, parts of consumer electronics products, varactors, liquid crystal devices, electrophoretic devices, drive schemes, manufacturing processes, and electronic test equipment. Thus, the teachings are not intended to be limited to the implementations depicted solely in the Figures, but instead have wide applicability as will be readily apparent to a person having ordinary skill in the art.

Various implementations of methods and apparatus that reduce low-tone half-tone pattern visibility are disclosed herein. One implementation of a proposed method and apparatus reduces continuous-tone (24 bits per pixel) images to the bit-depth of an electronic display (e.g., 6 bits per pixel) using a half-toning process that crushes input pixel values by setting half-toned pixel values to a certain “crush value” if the corresponding input pixel value is below a crush threshold. In some implementations, the crush threshold may be the same for all color channels (e.g., red, green and blue). Alternatively, at least one of the color channels (e.g., green) may have a different crush threshold. In some implementations, the crush value may be zero (0). The process also determines a quantization error based on the crushed value and the input pixel value, and then diffuses the error. By accumulating and distributing quantization error for crushed pixels, the intensity of each local region of the half-toned image may be maintained.

Some of the methods and apparatus that crush pixels and distribute a quantization error may also perform hybrid half-toning. In some implementations of hybrid half-toning, multiple half-toning methods are performed on each input pixel of an image to generate multiple half-tone values for the input pixel. After the multiple half-tone values are generated, one of the half-tone values is selected for the pixel based on the properties of the pixel and its neighboring pixels. In some implementations, at least two half-tone values of each input pixel of an image are generated and one of the at least two half-tone values is selected to generate an output pixel based on local image content of a neighborhood of the respective input pixel. These methods and apparatus may further improve the visual appearance of images rendered by reducing the visual artifacts associated with half-toning as applied in traditional methods.

Particular implementations of the subject matter described in this disclosure can be implemented to realize one or more of the following potential advantages. The visual appearance of images dithered with the disclosed methods may provide an improved visual appearance when compared to images dithered with traditional methods. For example, visual artifacts introduced by traditional methods can be reduced or eliminated. Loss of details in dark regions of an image may be reduced. Further, by crushing input pixels that are below the crush threshold, noises in low tone area of the image can be substantially suppressed. Some implementations of the methods and apparatus disclosed herein are particularly useful in reducing artifacts in images rendered by a low bit-depth device, such as low bit-depth printers and low bit-depth display devices.

An example of a suitable EMS or MEMS device, to which the described implementations may apply, is a reflective display device. Reflective display devices can incorporate interferometric modulators (IMODs) to selectively absorb and/or reflect light incident thereon using principles of optical interference. IMODs can include an absorber, a reflector that is movable with respect to the absorber, and an optical resonant cavity defined between the absorber and the reflector. The reflector can be moved to two or more different positions, which can change the size of the optical resonant cavity and thereby affect the reflectance of the interferometric modulator. The reflectance spectrums of IMODs can create fairly broad spectral bands which can be shifted across the visible wavelengths to generate different colors. The position of the spectral band can be adjusted by changing the thickness of the optical resonant cavity, i.e., by changing the position of the reflector.

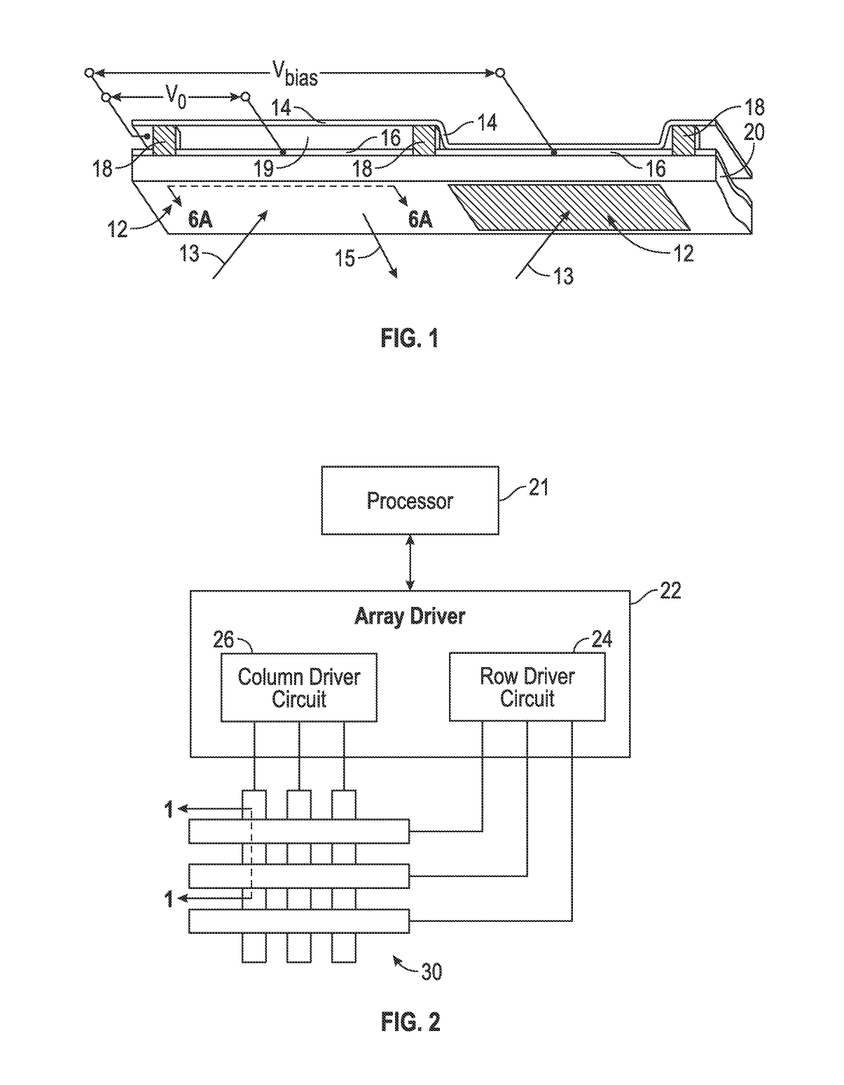

FIG. 1 shows an example of an isometric view depicting two adjacent pixels in a series of pixels of an interferometric modulator (IMOD) display device. The IMOD display device includes one or more interferometric MEMS display elements. In these devices, the pixels of the MEMS display elements can be in either a bright or dark state. In the bright (“relaxed,” “open” or “on”) state, the display element reflects a large portion of incident visible light, e.g., to a user. Conversely, in the dark (“actuated,” “closed” or “off”) state, the display element reflects little incident visible light. In some implementations, the light reflectance properties of the on and off states may be reversed. MEMS pixels can be configured to reflect predominantly at particular wavelengths allowing for a color display in addition to black and white.

The IMOD display device can include a row/column array of IMODs. Each IMOD can include a pair of reflective layers, i.e., a movable reflective layer and a fixed partially reflective layer, positioned at a variable and controllable distance from each other to form an air gap (also referred to as an optical gap or cavity). The movable reflective layer may be moved between at least two positions. In a first position, i.e., a relaxed position, the movable reflective layer can be positioned at a relatively large distance from the fixed partially reflective layer. In a second position, i.e., an actuated position, the movable reflective layer can be positioned more closely to the partially reflective layer. Incident light that reflects from the two layers can interfere constructively or destructively depending on the position of the movable reflective layer, producing either an overall reflective or non-reflective state for each pixel. In some implementations, the IMOD may be in a reflective state when unactuated, reflecting light within the visible spectrum, and may be in a dark state when actuated, absorbing and/or destructively interfering with light within the visible range. In some implementations, the introduction of an applied voltage can drive the pixels to change states. In some other implementations, an applied charge can drive the pixels to change states.

The depicted portion of the pixel array in FIG. 1 includes two adjacent interferometric modulators 12. In the IMOD 12 on the left (as illustrated), a movable reflective layer 14 is illustrated in a relaxed position at a predetermined distance from an optical stack 16, which includes a partially reflective layer. The voltage V₀ applied across the IMOD 12 on the left is insufficient to cause actuation of the movable reflective layer 14. In the IMOD 12 on the right, the movable reflective layer 14 is illustrated in an actuated position near or adjacent the optical stack 16. The voltage V_{bias} applied across the IMOD 12 on the right is sufficient to maintain the movable reflective layer 14 in the actuated position.

In FIG. 1, the reflective properties of pixels 12 are generally illustrated with arrows indicating light 13 incident upon the pixels 12, and light 15 reflecting from the pixel 12 on the left. Although not illustrated in detail, it will be understood by a person having ordinary skill in the art that most of the light 13 incident upon the pixels 12 will be transmitted through the transparent substrate 20, toward the optical stack 16. A portion of the light incident upon the optical stack 16 will be transmitted through the partially reflective layer of the optical stack 16, and a portion will be reflected back through the transparent substrate 20. The portion of light 13 that is transmitted through the optical stack 16 will be reflected at the movable reflective layer 14, back toward (and through) the transparent substrate 20. Interference (constructive or destructive) between the light reflected from the partially reflective layer of the optical stack 16 and the light reflected from the movable reflective layer 14 will determine the wavelength(s) of light 15 reflected from the pixel 12.

The optical stack 16 can include a single layer or several layers. The layer(s) can include one or more of an electrode layer, a partially reflective and partially transmissive layer and a transparent dielectric layer. In some implementations, the optical stack 16 is electrically conductive, partially transparent and partially reflective, and may be fabricated, for example, by depositing one or more of the above layers onto a transparent substrate 20. The electrode layer can be formed from a variety of materials, such as various metals, for example indium tin oxide (ITO). The partially reflective layer can be formed from a variety of materials that are partially reflective, such as various metals, e.g., chromium (Cr), semiconductors, and dielectrics. The partially reflective layer can be formed of one or more layers of materials, and each of the layers can be formed of a single material or a combination of materials. In some implementations, the optical stack 16 can include a single semi-transparent thickness of metal or semiconductor which serves as both an optical absorber and electrical conductor, while different, electrically more conductive layers or portions (e.g., of the optical stack 16 or of other structures of the IMOD) can serve to bus signals between IMOD pixels. The optical stack 16 also can include one or more insulating or dielectric layers covering one or more conductive layers or an electrically conductive/optically absorptive layer.

In some implementations, the layer(s) of the optical stack 16 can be patterned into parallel strips, and may form row electrodes in a display device as described further below. As will be understood by one having ordinary skill in the art, the term “patterned” is used herein to refer to masking as well as etching processes. In some implementations, a highly conductive and reflective material, such as aluminum (Al), may be used for the movable reflective layer 14, and these strips may form column electrodes in a display device. The movable reflective layer 14 may be formed as a series of parallel strips of a deposited metal layer or layers (orthogonal to the row electrodes of the optical stack 16) to form columns deposited on top of posts 18 and an intervening sacrificial material deposited between the posts 18. When the sacrificial material is etched away, a defined gap 19, or optical cavity, can be formed between the movable reflective layer 14 and the optical stack 16. In some implementations, the spacing between posts 18 may be approximately 1-1000 um, while the gap 19 may be less than 10,000 Angstroms (Å).

In some implementations, each pixel of the IMOD, whether in the actuated or relaxed state, is essentially a capacitor formed by the fixed and moving reflective layers. When no voltage is applied, the movable reflective layer 14 remains in a mechanically relaxed state, as illustrated by the pixel 12 on the left in FIG. 1, with the gap 19 between the movable reflective layer 14 and optical stack 16. However, when a potential difference, a voltage, is applied to at least one of a selected row and column, the capacitor formed at the intersection of the row and column electrodes at the corresponding pixel becomes charged, and electrostatic forces pull the electrodes together. If the applied voltage exceeds a threshold, the movable reflective layer 14 can deform and move near or against the optical stack 16. A dielectric layer (not shown) within the optical stack 16 may prevent shorting and control the separation distance between the layers 14 and 16, as illustrated by the actuated pixel 12 on the right in FIG. 1. The behavior is the same regardless of the polarity of the applied potential difference. Though a series of pixels in an array may be referred to in some instances as “rows” or “columns,” a person having ordinary skill in the art will readily understand that referring to one direction as a “row” and another as a “column” is arbitrary. Restated, in some orientations, the rows can be considered columns, and the columns considered to be rows. Furthermore, the display elements may be evenly arranged in orthogonal rows and columns (an “array”), or arranged in non-linear configurations, for example, having certain positional offsets with respect to one another (a “mosaic”). The terms “array” and “mosaic” may refer to either configuration. Thus, although the display is referred to as including an “array” or “mosaic,” the elements themselves need not be arranged orthogonally to one another, or disposed in an even distribution, in any instance, but may include arrangements having asymmetric shapes and unevenly distributed elements.

FIG. 2 shows an example of a system block diagram illustrating an electronic device incorporating a 3×3 interferometric modulator display. The electronic device includes a processor 21 that may be configured to execute one or more software modules. In addition to executing an operating system, the processor 21 may be configured to execute one or more software applications, including a web browser, a telephone application, an email program, or any other software application.

The processor 21 can be configured to communicate with an array driver 22. The array driver 22 can include a row driver circuit 24 and a column driver circuit 26 that provide signals to, e.g., a display array or panel 30. The cross section of the IMOD display device illustrated in FIG. 1 is shown by the lines 1-1 in FIG. 2. Although FIG. 2 illustrates a 3×3 array of IMODs for the sake of clarity, the display array 30 may contain a very large number of IMODs, and may have a different number of IMODs in rows than in columns, and vice versa.

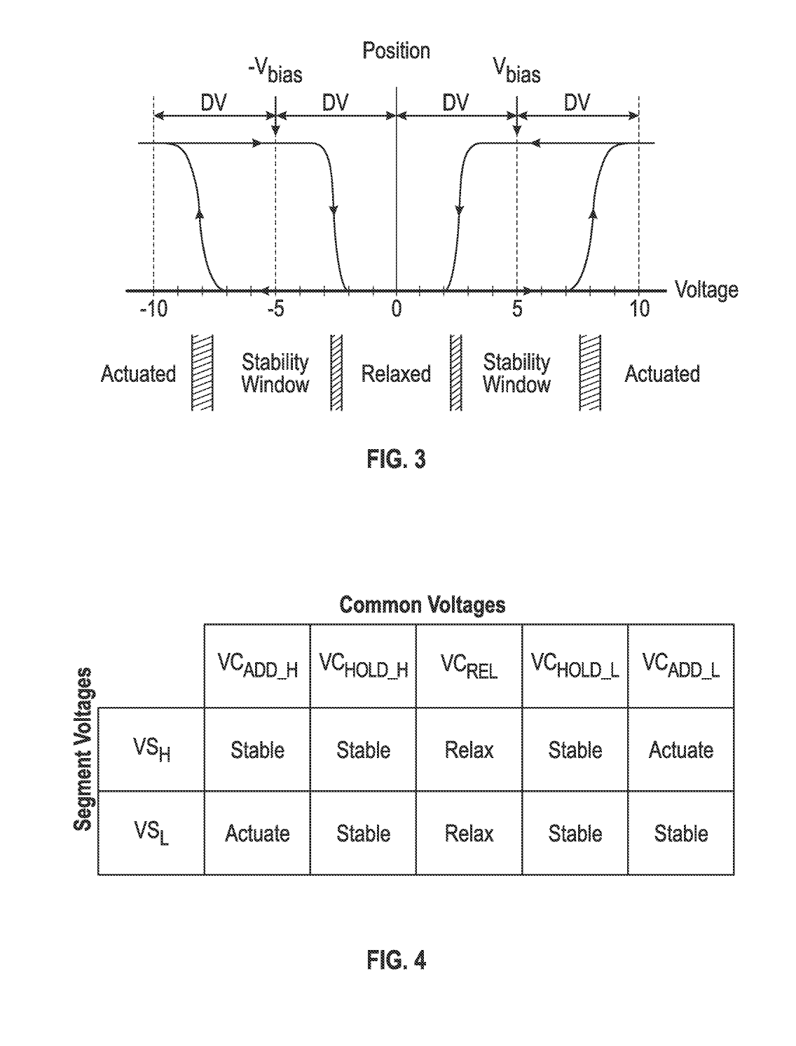

FIG. 3 shows an example of a diagram illustrating movable reflective layer position versus applied voltage for the interferometric modulator of FIG. 1. For MEMS interferometric modulators, the row/column (i.e., common/segment) write procedure may take advantage of a hysteresis property of these devices as illustrated in FIG. 3. An interferometric modulator may use, in one example implementation, about a 10-volt potential difference to cause the movable reflective layer, or mirror, to change from the relaxed state to the actuated state. When the voltage is reduced from that value, the movable reflective layer maintains its state as the voltage drops back below, in this example, 10 volts, however, the movable reflective layer does not relax completely until the voltage drops below 2 volts. Thus, a range of voltage, approximately 3 to 7 volts, in this example, as shown in FIG. 3, exists where there is a window of applied voltage within which the device is stable in either the relaxed or actuated state. This is referred to herein as the “hysteresis window” or “stability window.” For a display array 30 having the hysteresis characteristics of FIG. 3, the row/column write procedure can be designed to address one or more rows at a time, such that during the addressing of a given row, pixels in the addressed row that are to be actuated are exposed to a voltage difference of about, in this example, 10 volts, and pixels that are to be relaxed are exposed to a voltage difference of near zero volts. After addressing, the pixels can be exposed to a steady state or bias voltage difference of approximately 5 volts in this example, such that they remain in the previous strobing state. In this example, after being addressed, each pixel sees a potential difference within the “stability window” of about 3-7 volts. This hysteresis property feature enables the pixel design, such as that illustrated in FIG. 1, to remain stable in either an actuated or relaxed pre-existing state under the same applied voltage conditions. Since each IMOD pixel, whether in the actuated or relaxed state, is essentially a capacitor formed by the fixed and moving reflective layers, this stable state can be held at a steady voltage within the hysteresis window without substantially consuming or losing power. Moreover, essentially little or no current flows into the IMOD pixel if the applied voltage potential remains substantially fixed.

In some implementations, a frame of an image may be created by applying data signals in the form of “segment” voltages along the set of column electrodes, in accordance with the desired change (if any) to the state of the pixels in a given row. Each row of the array can be addressed in turn, such that the frame is written one row at a time. To write the desired data to the pixels in a first row, segment voltages corresponding to the desired state of the pixels in the first row can be applied on the column electrodes, and a first row pulse in the form of a specific “common” voltage or signal can be applied to the first row electrode. The set of segment voltages can then be changed to correspond to the desired change (if any) to the state of the pixels in the second row, and a second common voltage can be applied to the second row electrode. In some implementations, the pixels in the first row are unaffected by the change in the segment voltages applied along the column electrodes, and remain in the state they were set to during the first common voltage row pulse. This process may be repeated for the entire series of rows, or alternatively, columns, in a sequential fashion to produce the image frame. The frames can be refreshed and/or updated with new image data by continually repeating this process at some desired number of frames per second.

The combination of segment and common signals applied across each pixel (that is, the potential difference across each pixel) determines the resulting state of each pixel. FIG. 4 shows an example of a table illustrating various states of an interferometric modulator when various common and segment voltages are applied. As will be understood by one having ordinary skill in the art, the “segment” voltages can be applied to either the column electrodes or the row electrodes, and the “common” voltages can be applied to the other of the column electrodes or the row electrodes.

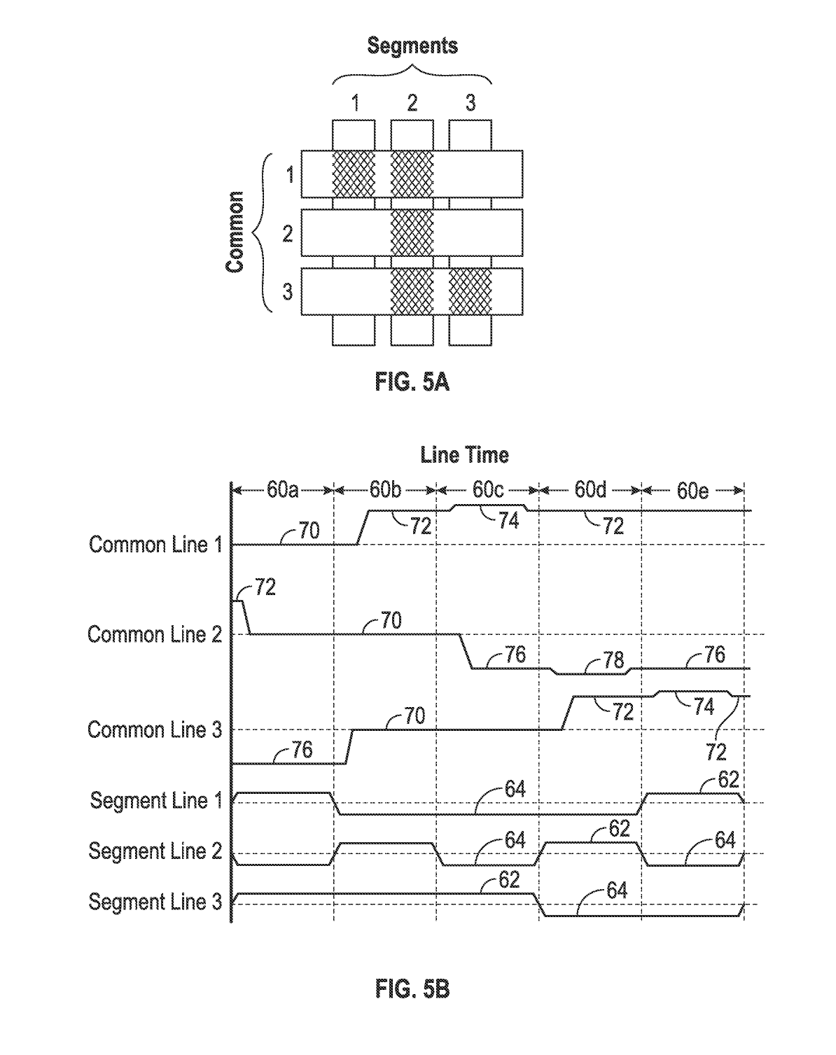

As illustrated in FIG. 4 (as well as in the timing diagram shown in FIG. 5B), when a release voltage VC_{REL} is applied along a common line, all interferometric modulator elements along the common line will be placed in a relaxed state, alternatively referred to as a released or unactuated state, regardless of the voltage applied along the segment lines, i.e., high segment voltage VS_{H} and low segment voltage VS_{L}. In particular, when the release voltage VC_{REL} is applied along a common line, the potential voltage across the modulator pixels (alternatively referred to as a pixel voltage) is within the relaxation window (see FIG. 3, also referred to as a release window) both when the high segment voltage VS_{H} and the low segment voltage VS_{L} are applied along the corresponding segment line for that pixel.

When a hold voltage is applied on a common line, such as a high hold voltage VC_{HOLD}_{_{—}}_{H} or a low hold voltage VC_{HOLD}_{_{—}}_{L}, the state of the interferometric modulator will remain constant. For example, a relaxed IMOD will remain in a relaxed position, and an actuated IMOD will remain in an actuated position. The hold voltages can be selected such that the pixel voltage will remain within a stability window both when the high segment voltage VS_{H} and the low segment voltage VS_{L} are applied along the corresponding segment line. Thus, the segment voltage swing, i.e., the difference between the high VS_{H} and low segment voltage VS_{L}, is less than the width of either the positive or the negative stability window.

When an addressing, or actuation, voltage is applied on a common line, such as a high addressing voltage VC_{ADD}_{_{—}}_{H} or a low addressing voltage VC_{ADD}_{_{—}}_{L}, data can be selectively written to the modulators along that line by application of segment voltages along the respective segment lines. The segment voltages may be selected such that actuation is dependent upon the segment voltage applied. When an addressing voltage is applied along a common line, application of one segment voltage will result in a pixel voltage within a stability window, causing the pixel to remain unactuated. In contrast, application of the other segment voltage will result in a pixel voltage beyond the stability window, resulting in actuation of the pixel. The particular segment voltage which causes actuation can vary depending upon which addressing voltage is used. In some implementations, when the high addressing voltage VC_{ADD}_{_{—}}_{H} is applied along the common line, application of the high segment voltage VS_{H} can cause a modulator to remain in its current position, while application of the low segment voltage VS_{L} can cause actuation of the modulator. As a corollary, the effect of the segment voltages can be the opposite when a low addressing voltage VC_{ADD}_{_{—}}_{L} is applied, with high segment voltage VS_{H} causing actuation of the modulator, and low segment voltage VS_{L} having no effect (i.e., remaining stable) on the state of the modulator.

In some implementations, hold voltages, address voltages, and segment voltages may be used which produce the same polarity potential difference across the modulators. In some other implementations, signals can be used which alternate the polarity of the potential difference of the modulators from time to time. Alternation of the polarity across the modulators (that is, alternation of the polarity of write procedures) may reduce or inhibit charge accumulation which could occur after repeated write operations of a single polarity.

FIG. 5A shows an example of a diagram illustrating a frame of display data in the 3×3 interferometric modulator display of FIG. 2. FIG. 5B shows an example of a timing diagram for common and segment signals that may be used to write the frame of display data illustrated in FIG. 5A. The signals can be applied to a 3×3 array, similar to the array of FIG. 2, which will ultimately result in the line time 60e display arrangement illustrated in FIG. 5A. The actuated modulators in FIG. 5A are in a dark-state, i.e., where a substantial portion of the reflected light is outside of the visible spectrum so as to result in a dark appearance to, for example, a viewer. Prior to writing the frame illustrated in FIG. 5A, the pixels can be in any state, but the write procedure illustrated in the timing diagram of FIG. 5B presumes that each modulator has been released and resides in an unactuated state before the first line time 60a.

During the first line time 60a: a release voltage 70 is applied on common line 1; the voltage applied on common line 2 begins at a high hold voltage 72 and moves to a release voltage 70; and a low hold voltage 76 is applied along common line 3. Thus, the modulators (common 1, segment 1), (1,2) and (1,3) along common line 1 remain in a relaxed, or unactuated, state for the duration of the first line time 60a, the modulators (2,1), (2,2) and (2,3) along common line 2 will move to a relaxed state, and the modulators (3,1), (3,2) and (3,3) along common line 3 will remain in their previous state. With reference to FIG. 4, the segment voltages applied along segment lines 1, 2 and 3 will have no effect on the state of the interferometric modulators, as none of common lines 1, 2 or 3 are being exposed to voltage levels causing actuation during line time 60a (i.e., VC_{REL}—relax and VC_{HOLD}_{_{—}}_{L}—stable).

During the second line time 60b, the voltage on common line 1 moves to a high hold voltage 72, and all modulators along common line 1 remain in a relaxed state regardless of the segment voltage applied because no addressing, or actuation, voltage was applied on the common line 1. The modulators along common line 2 remain in a relaxed state due to the application of the release voltage 70, and the modulators (3,1), (3,2) and (3,3) along common line 3 will relax when the voltage along common line 3 moves to a release voltage 70.

During the third line time 60c, common line 1 is addressed by applying a high address voltage 74 on common line 1. Because a low segment voltage 64 is applied along segment lines 1 and 2 during the application of this address voltage, the pixel voltage across modulators (1,1) and (1,2) is greater than the high end of the positive stability window (i.e., the voltage differential exceeded a predefined threshold) of the modulators, and the modulators (1,1) and (1,2) are actuated. Conversely, because a high segment voltage 62 is applied along segment line 3, the pixel voltage across modulator (1,3) is less than that of modulators (1,1) and (1,2), and remains within the positive stability window of the modulator; modulator (1,3) thus remains relaxed. Also during line time 60c, the voltage along common line 2 decreases to a low hold voltage 76, and the voltage along common line 3 remains at a release voltage 70, leaving the modulators along common lines 2 and 3 in a relaxed position.

During the fourth line time 60d, the voltage on common line 1 returns to a high hold voltage 72, leaving the modulators along common line 1 in their respective addressed states. The voltage on common line 2 is decreased to a low address voltage 78. Because a high segment voltage 62 is applied along segment line 2, the pixel voltage across modulator (2,2) is below the lower end of the negative stability window of the modulator, causing the modulator (2,2) to actuate. Conversely, because a low segment voltage 64 is applied along segment lines 1 and 3, the modulators (2,1) and (2,3) remain in a relaxed position. The voltage on common line 3 increases to a high hold voltage 72, leaving the modulators along common line 3 in a relaxed state.

Finally, during the fifth line time 60e, the voltage on common line 1 remains at high hold voltage 72, and the voltage on common line 2 remains at a low hold voltage 76, leaving the modulators along common lines 1 and 2 in their respective addressed states. The voltage on common line 3 increases to a high address voltage 74 to address the modulators along common line 3. As a low segment voltage 64 is applied on segment lines 2 and 3, the modulators (3,2) and (3,3) actuate, while the high segment voltage 62 applied along segment line 1 causes modulator (3,1) to remain in a relaxed position. Thus, at the end of the fifth line time 60e, the 3×3 pixel array is in the state shown in FIG. 5A, and will remain in that state as long as the hold voltages are applied along the common lines, regardless of variations in the segment voltage which may occur when modulators along other common lines (not shown) are being addressed.

In the timing diagram of FIG. 5B, a given write procedure (i.e., line times 60a-60e) can include the use of either high hold and address voltages, or low hold and address voltages. Once the write procedure has been completed for a given common line (and the common voltage is set to the hold voltage having the same polarity as the actuation voltage), the pixel voltage remains within a given stability window, and does not pass through the relaxation window until a release voltage is applied on that common line. Furthermore, as each modulator is released as part of the write procedure prior to addressing the modulator, the actuation time of a modulator, rather than the release time, may determine the line time. Specifically, in implementations in which the release time of a modulator is greater than the actuation time, the release voltage may be applied for longer than a single line time, as depicted in FIG. 5B. In some other implementations, voltages applied along common lines or segment lines may vary to account for variations in the actuation and release voltages of different modulators, such as modulators of different colors.

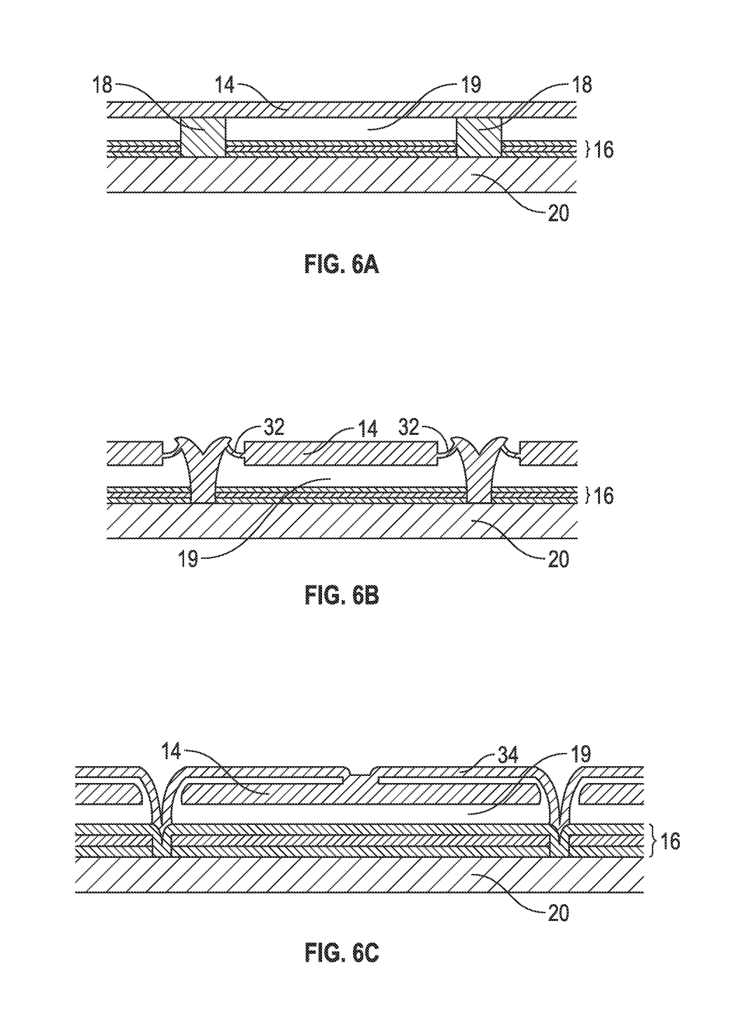

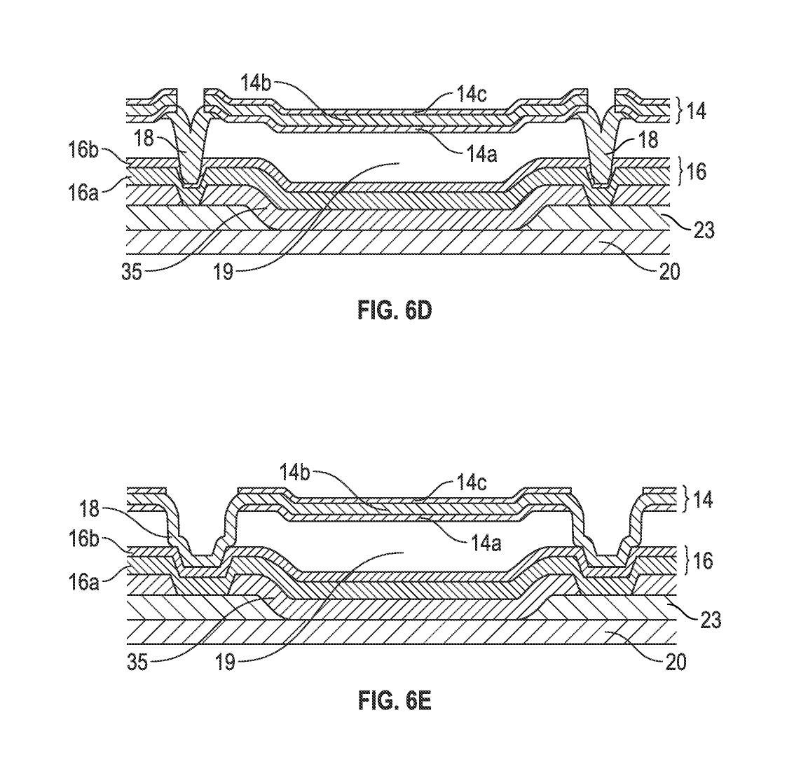

The details of the structure of interferometric modulators that operate in accordance with the principles set forth above may vary widely. For example, FIGS. 6A-6E show examples of cross-sections of varying implementations of interferometric modulators, including the movable reflective layer 14 and its supporting structures. FIG. 6A shows an example of a partial cross-section of the interferometric modulator display of FIG. 1, where a strip of metal material, i.e., the movable reflective layer 14 is deposited on supports 18 extending orthogonally from the substrate 20. In FIG. 6B, the movable reflective layer 14 of each IMOD is generally square or rectangular in shape and attached to supports at or near the corners, on tethers 32. In FIG. 6C, the movable reflective layer 14 is generally square or rectangular in shape and suspended from a deformable layer 34, which may include a flexible metal. The deformable layer 34 can connect, directly or indirectly, to the substrate 20 around the perimeter of the movable reflective layer 14. These connections are herein referred to as support posts. The implementation shown in FIG. 6C has additional benefits deriving from the decoupling of the optical functions of the movable reflective layer 14 from its mechanical functions, which are carried out by the deformable layer 34. This decoupling allows the structural design and materials used for the reflective layer 14 and those used for the deformable layer 34 to be optimized independently of one another.

FIG. 6D shows another example of an IMOD, where the movable reflective layer 14 includes a reflective sub-layer 14a. The movable reflective layer 14 rests on a support structure, such as support posts 18. The support posts 18 provide separation of the movable reflective layer 14 from the lower stationary electrode (i.e., part of the optical stack 16 in the illustrated IMOD) so that a gap 19 is formed between the movable reflective layer 14 and the optical stack 16, for example when the movable reflective layer 14 is in a relaxed position. The movable reflective layer 14 also can include a conductive layer 14c, which may be configured to serve as an electrode, and a support layer 14b. In this example, the conductive layer 14c is disposed on one side of the support layer 14b, distal from the substrate 20, and the reflective sub-layer 14a is disposed on the other side of the support layer 14b, proximal to the substrate 20. In some implementations, the reflective sub-layer 14a can be conductive and can be disposed between the support layer 14b and the optical stack 16. The support layer 14b can include one or more layers of a dielectric material, for example, silicon oxynitride (SiON) or silicon dioxide (SiO₂). In some implementations, the support layer 14b can be a stack of layers, such as, for example, a SiO₂/SiON/SiO₂ tri-layer stack. Either or both of the reflective sub-layer 14a and the conductive layer 14c can include, e.g., an aluminum (Al) alloy with about 0.5% copper (Cu), or another reflective metallic material. Employing conductive layers 14a, 14c above and below the dielectric support layer 14b can balance stresses and provide enhanced conduction. In some implementations, the reflective sub-layer 14a and the conductive layer 14c can be formed of different materials for a variety of design purposes, such as achieving specific stress profiles within the movable reflective layer 14.

As illustrated in FIG. 6D, some implementations also can include a black mask structure 23. The black mask structure 23 can be formed in optically inactive regions (e.g., between pixels or under posts 18) to absorb ambient or stray light. The black mask structure 23 also can improve the optical properties of a display device by inhibiting light from being reflected from or transmitted through inactive portions of the display, thereby increasing the contrast ratio. Additionally, the black mask structure 23 can be conductive and be configured to function as an electrical bussing layer. In some implementations, the row electrodes can be connected to the black mask structure 23 to reduce the resistance of the connected row electrode. The black mask structure 23 can be formed using a variety of methods, including deposition and patterning techniques. The black mask structure 23 can include one or more layers. For example, in some implementations, the black mask structure 23 includes a molybdenum-chromium (MoCr) layer that serves as an optical absorber, a layer, and an aluminum alloy that serves as a reflector and a bussing layer, with a thickness in the range of about 30-80 Å, 500-1000 Å, and 500-6000 Å, respectively. The one or more layers can be patterned using a variety of techniques, including photolithography and dry etching, including, for example, carbon tetrafluoride (CF₄) and/or oxygen (O₂) for the MoCr and SiO₂ layers and chlorine (Cl₂) and/or boron trichloride (BCl₃) for the aluminum alloy layer. In some implementations, the black mask 23 can be an etalon or interferometric stack structure. In such interferometric stack black mask structures 23, the conductive absorbers can be used to transmit or bus signals between lower, stationary electrodes in the optical stack 16 of each row or column. In some implementations, a spacer layer 35 can serve to generally electrically isolate the absorber layer 16a from the conductive layers in the black mask 23.

FIG. 6E shows another example of an IMOD, where the movable reflective layer 14 is self-supporting. In contrast with FIG. 6D, the implementation of FIG. 6E does not include support posts 18. Instead, the movable reflective layer 14 contacts the underlying optical stack 16 at multiple locations, and the curvature of the movable reflective layer 14 provides sufficient support that the movable reflective layer 14 returns to the unactuated position of FIG. 6E when the voltage across the interferometric modulator is insufficient to cause actuation. The optical stack 16, which may contain a plurality of several different layers, is shown here for clarity including an optical absorber 16a, and a dielectric 16b. In some implementations, the optical absorber 16a may serve both as a fixed electrode and as a partially reflective layer.

In implementations such as those shown in FIGS. 6A-6E, the IMODs function as direct-view devices, in which images are viewed from the front side of the transparent substrate 20, i.e., the side opposite to that upon which the modulator is arranged. In these implementations, the back portions of the device (that is, any portion of the display device behind the movable reflective layer 14, including, for example, the deformable layer 34 illustrated in FIG. 6C) can be configured and operated upon without impacting or negatively affecting the image quality of the display device, because the reflective layer 14 optically shields those portions of the device. For example, in some implementations a bus structure (not illustrated) can be included behind the movable reflective layer 14 which provides the ability to separate the optical properties of the modulator from the electromechanical properties of the modulator, such as voltage addressing and the movements that result from such addressing. Additionally, the implementations of FIGS. 6A-6E can simplify processing, such as, for example, patterning.

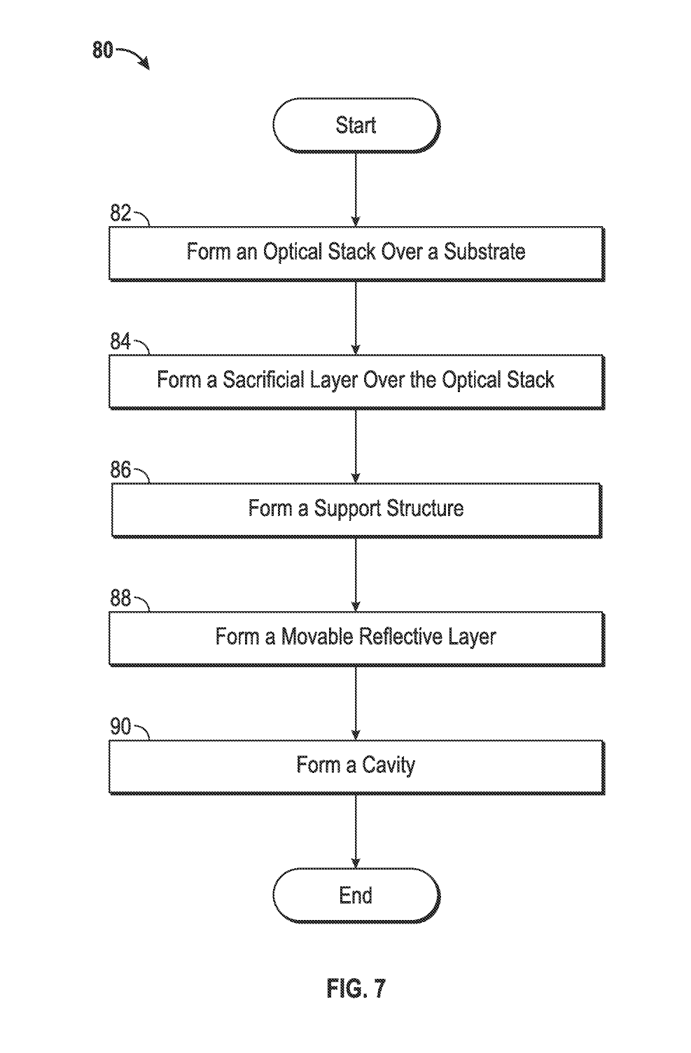

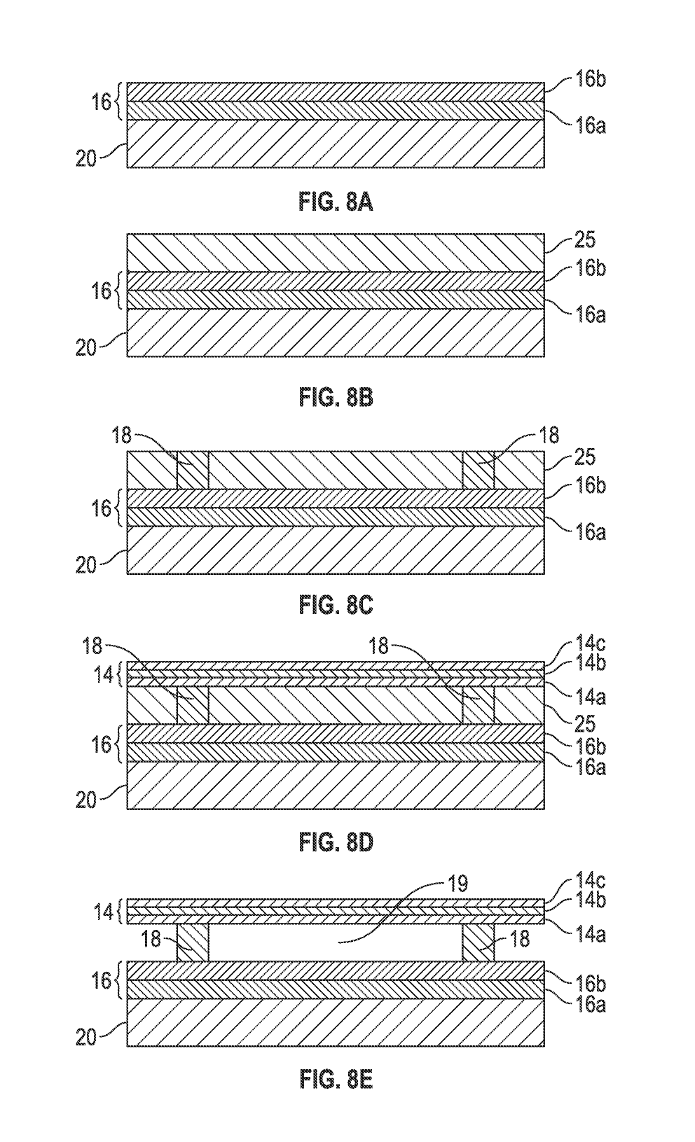

FIG. 7 shows an example of a flow diagram illustrating a manufacturing process 80 for an interferometric modulator, and FIGS. 8A-8E show examples of cross-sectional schematic illustrations of corresponding stages of such a manufacturing process 80. In some implementations, the manufacturing process 80 can be implemented to manufacture an electromechanical systems device such as interferometric modulators of the general type illustrated in FIGS. 1 and 6. The manufacture of an electromechanical systems device can also include other blocks not shown in FIG. 7. With reference to FIGS. 1, 6 and 7, the process 80 begins at block 82 with the formation of the optical stack 16 over the substrate 20. FIG. 8A illustrates such an optical stack 16 formed over the substrate 20. The substrate 20 may be a transparent substrate such as glass or plastic, it may be flexible or relatively stiff and unbending, and may have been subjected to prior preparation processes, e.g., cleaning, to facilitate efficient formation of the optical stack 16. As discussed above, the optical stack 16 can be electrically conductive, partially transparent and partially reflective and may be fabricated, for example, by depositing one or more layers having the desired properties onto the transparent substrate 20. In FIG. 8A, the optical stack 16 includes a multilayer structure having sub-layers 16a and 16b, although more or fewer sub-layers may be included in some other implementations. In some implementations, one of the sub-layers 16a and 16b can be configured with both optically absorptive and electrically conductive properties, such as the combined conductor/absorber sub-layer 16a. Additionally, one or more of the sub-layers 16a and 16b can be patterned into parallel strips, and may form row electrodes in a display device. Such patterning can be performed by a masking and etching process or another suitable process known in the art. In some implementations, one of the sub-layers 16a, 16b can be an insulating or dielectric layer, such as sub-layer 16b that is deposited over one or more metal layers (e.g., one or more reflective and/or conductive layers). In addition, the optical stack 16 can be patterned into individual and parallel strips that form the rows of the display. It is noted that FIGS. 8A-8E may not be drawn to scale. For example, in some implementations, one of the sub-layers of the optical stack, the optically absorptive layer, may be very thin, although sub-layers 16a, 16b are shown somewhat thick in FIGS. 8A-8E.

The process 80 continues at block 84 with the formation of a sacrificial layer 25 over the optical stack 16. The sacrificial layer 25 is later removed (e.g., at block 90) to form the cavity 19 and thus the sacrificial layer 25 is not shown in the resulting interferometric modulators 12 illustrated in FIG. 1. FIG. 8B illustrates a partially fabricated device including a sacrificial layer 25 formed over the optical stack 16. The formation of the sacrificial layer 25 over the optical stack 16 may include deposition of a xenon difluoride (XeF₂)-etchable material such as molybdenum (Mo) or amorphous silicon (a-Si), in a thickness selected to provide, after subsequent removal, a gap or cavity 19 (see also FIGS. 1 and 8E) having a desired design size. Deposition of the sacrificial material may be carried out using deposition techniques such as physical vapor deposition (PVD, e.g., sputtering), plasma-enhanced chemical vapor deposition (PECVD), thermal chemical vapor deposition (thermal CVD), or spin-coating.

The process 80 continues at block 86 with the formation of a support structure e.g., a post 18 as illustrated in FIGS. 1, 6 and 8C. The formation of the post 18 may include patterning the sacrificial layer 25 to form a support structure aperture, then depositing a material (e.g., a polymer or an inorganic material, e.g., silicon oxide) into the aperture to form the post 18, using a deposition method such as PVD, PECVD, thermal CVD, or spin-coating. In some implementations, the support structure aperture formed in the sacrificial layer can extend through both the sacrificial layer 25 and the optical stack 16 to the underlying substrate 20, so that the lower end of the post 18 contacts the substrate 20 as illustrated in FIG. 6A. Alternatively, as depicted in FIG. 8C, the aperture formed in the sacrificial layer 25 can extend through the sacrificial layer 25, but not through the optical stack 16. For example, FIG. 8E illustrates the lower ends of the support posts 18 in contact with an upper surface of the optical stack 16. The post 18, or other support structures, may be formed by depositing a layer of support structure material over the sacrificial layer 25 and patterning portions of the support structure material located away from apertures in the sacrificial layer 25. The support structures may be located within the apertures, as illustrated in FIG. 8C, but also can, at least partially, extend over a portion of the sacrificial layer 25. As noted above, the patterning of the sacrificial layer 25 and/or the support posts 18 can be performed by a patterning and etching process, but also may be performed by alternative etching methods.

The process 80 continues at block 88 with the formation of a movable reflective layer or membrane such as the movable reflective layer 14 illustrated in FIGS. 1, 6 and 8D. The movable reflective layer 14 may be formed by employing one or more deposition steps including, for example, reflective layer (e.g., aluminum, aluminum alloy, or other reflective layer) deposition, along with one or more patterning, masking, and/or etching steps. The movable reflective layer 14 can be electrically conductive, and referred to as an electrically conductive layer. In some implementations, the movable reflective layer 14 may include a plurality of sub-layers 14a, 14b, 14c as shown in FIG. 8D. In some implementations, one or more of the sub-layers, such as sub-layers 14a, 14c, may include highly reflective sub-layers selected for their optical properties, and another sub-layer 14b may include a mechanical sub-layer selected for its mechanical properties. Since the sacrificial layer 25 is still present in the partially fabricated interferometric modulator formed at block 88, the movable reflective layer 14 is typically not movable at this stage. A partially fabricated IMOD that contains a sacrificial layer 25 also may be referred to herein as an “unreleased” IMOD. As described above in connection with FIG. 1, the movable reflective layer 14 can be patterned into individual and parallel strips that form the columns of the display.

The process 80 continues at block 90 with the formation of a cavity, e.g., cavity 19 as illustrated in FIGS. 1, 6 and 8E. The cavity 19 may be formed by exposing the sacrificial material 25 (deposited at block 84) to an etchant. For example, an etchable sacrificial material such as Mo or amorphous Si may be removed by dry chemical etching, e.g., by exposing the sacrificial layer 25 to a gaseous or vaporous etchant, such as vapors derived from solid XeF₂ for a period of time that is effective to remove the desired amount of material, typically selectively removed relative to the structures surrounding the cavity 19. Other etching methods, e.g. wet etching and/or plasma etching, also may be used. Since the sacrificial layer 25 is removed during block 90, the movable reflective layer 14 is typically movable after this stage. After removal of the sacrificial material 25, the resulting fully or partially fabricated IMOD may be referred to herein as a “released” IMOD.

The human visual system is more sensitive to contrast (the difference in luminance between features) than to the absolute luminance of a field. This observation is reflected in Weber's law, the just-noticeable difference between two stimuli is proportional to the magnitude of the stimuli.

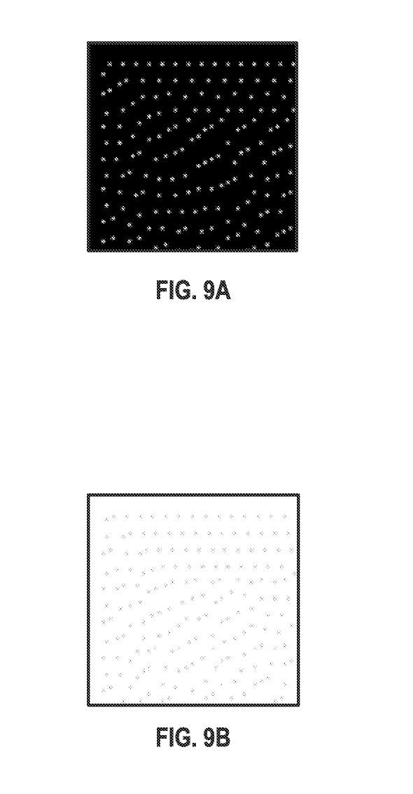

In the context of the visibility of noise (or patterns) in half-toned images, Weber's law indicates that noise (or patterns) of similar energy will be more visible on a dark background, rather than on a bright background. Consequently, half-tone patterns will be more objectionable in low-tone regions of an image than in mid or high tone regions of the image. FIGS. 9A and 9B illustrate this observation.

FIG. 9A shows a half-tone pattern with a foreground level of one (1) on a background of level of two (2). FIG. 9B shows a half-tone pattern having a similar Signal to Noise Ratio (SNR), as measured by the SNR mean or variance, to that of FIG. 9A. FIG. 9B has a foreground level of three (3) and a background level of four (4). Note that the half-tone pattern is more readily visible in FIG. 9A than in FIG. 9B.

One method of mitigating noisy appearance of low-tone levels is to crush the low tone level pixels. Crushing pixels may include setting all pixel values less than a particular threshold to a crush value. In some implementations, the crush value is zero. In other implementations, the crush value may be a non-zero value.

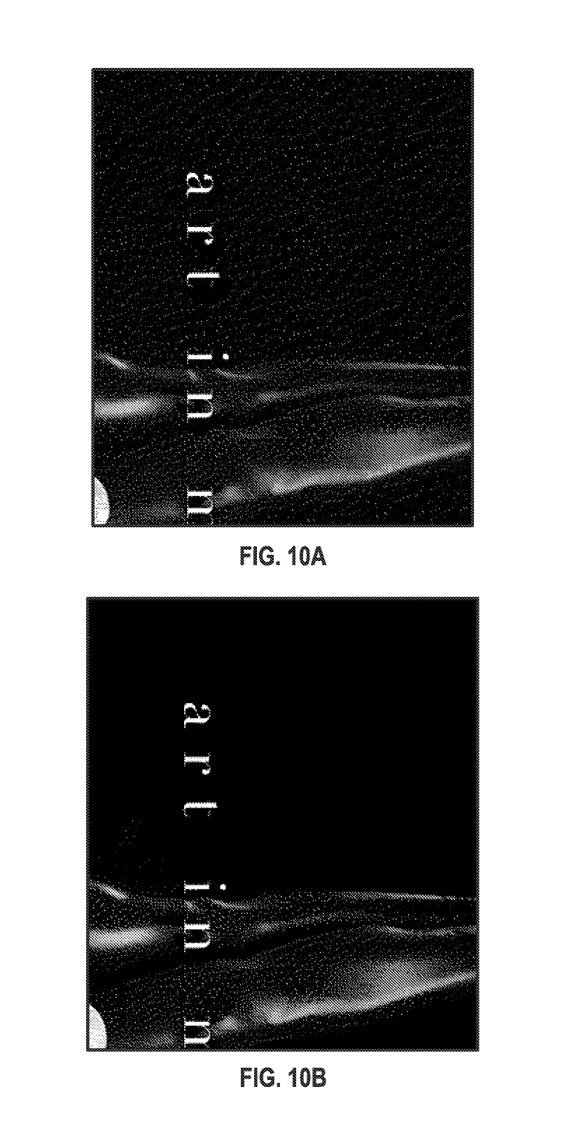

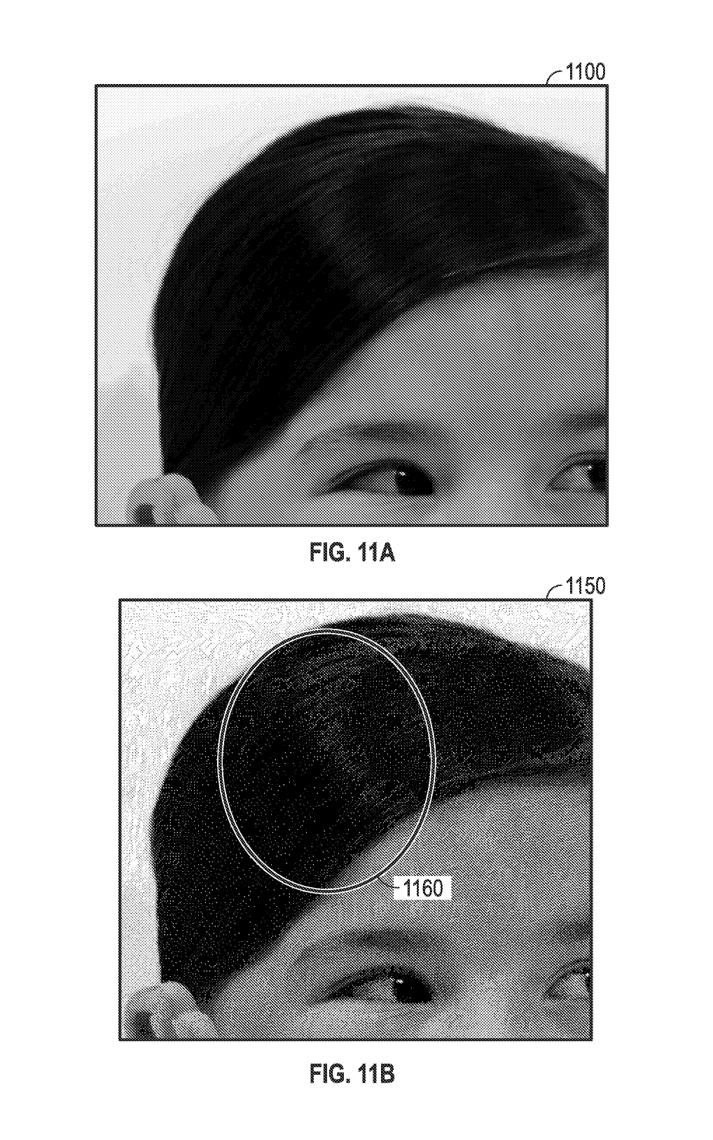

FIG. 10A and FIG. 10B show two images that demonstrate crushing input pixel values that are below a threshold. FIG. 10A shows a half-toned image. FIG. 10B shows the same half-toned image processed by crushing all pixel values less than a threshold to a crush value. In the illustrated FIG. 10B, a crush value of zero (0) was used. Note that the dark background appears less noisy in FIG. 10B.

In some implementations, alternate methods may be used to mitigate the appearance of noise in low tone levels. One alternate method sets green plane pixel values to zero if the values of the red, green and blue planes of the respective pixel are below a single threshold value. In this method, the values of the red and blue planes may not be set to zero even if the RGB planes of the pixel are all below the threshold value.

Another alternative method may provide for different crush thresholds for different color channels. For example, in one implementation, a green channel may be compared to a first threshold while a red and blue channel are compared to a second threshold. In this implementation, the green channel is crushed if it is below the first threshold, while the red and blue channels are crushed if they are below the second threshold. In another implementation, each color channel may have a unique crush threshold. Each channel may be crushed in this implementation if the channel is below its respective threshold.

These alternative methods exploit the fact that since the green channel may have the highest luminance, it may offer the highest gain in contrast against a black background. Therefore, crushing the green channel may provide the most improvement in visual appearance in at least some implementations.

In some implementations, crushing pixel values may result in a loss of feature detail in an image. For example, in these implementations, a particular input pixel value may be crushed based on the values of the RGB planes at its location. Information from the neighborhood surrounding the pixel may not be used to determine whether to crush one or more of the values at that location. This may lead to loss of image features in dark areas.

FIGS. 11A-B show an example of the loss of image features in dark areas after pixels have been crushed. FIG. 11A shows a gamut mapped image and FIG. 11B shows the same image after a half-toning process that includes crushing pixels below a threshold. The dark areas (marked with the circle 1160) may lose their texture. Additionally, some large black areas may appear in the image when the crush method is used to suppress noise in low tone areas.

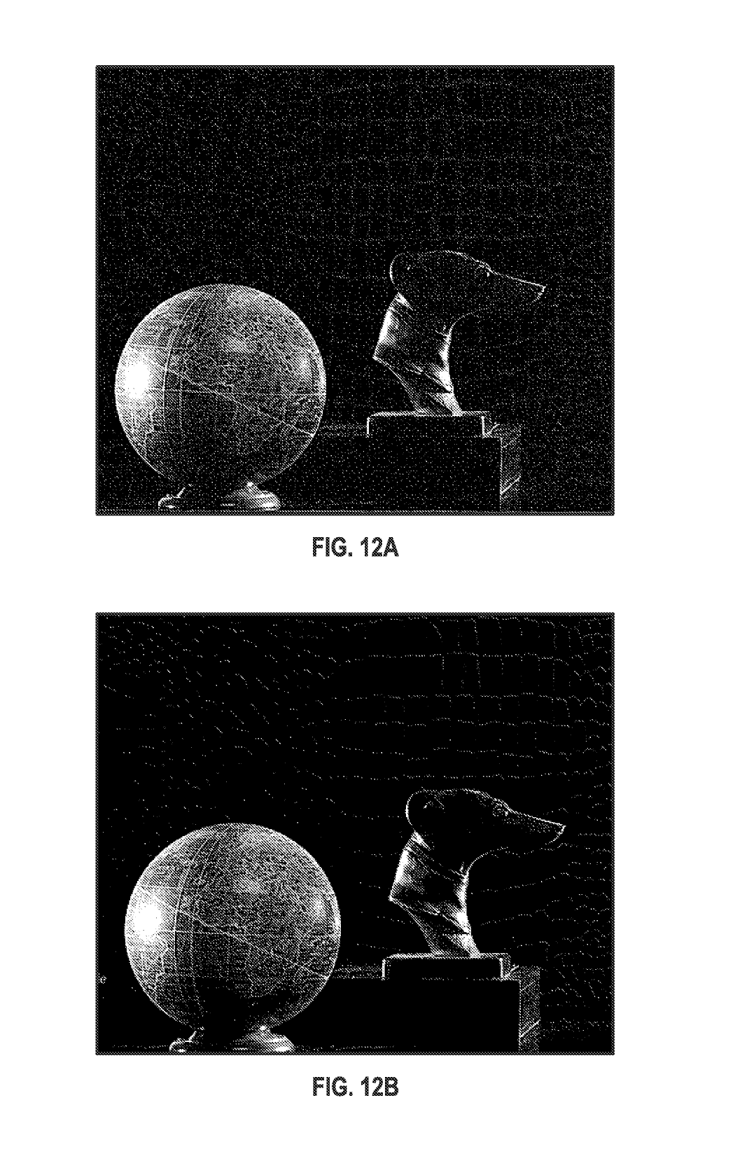

FIGS. 12A-B also show a representation of a digital image before and after a process of mitigating the noisy appearance of low-tone levels has been applied to the image The implementation that generated the results of FIGS. 12A-B mitigated the noisy appearance of low-tone levels by setting all pixel values less than a particular threshold value to zero. FIG. 12A shows an original version of the image. Note the noisy appearance of the background of FIG. 12A, for example, in the top right corner. FIG. 12B shows the same image processed after crushing all pixel values less than a threshold. Note the dark background appears less noisy. However, some image features are also lost in FIG. 12B. For example, some of the vertical lines visible in FIG. 12A have been affected such that the vertical lines are less visible, not visible, or have been removed by the crush process.

To avoid the loss of features observed in FIGS. 11B and 12B, the implementations described herein reduce noisy appearance of dark areas of an image by incorporating the crush process (described above and in further detail below) into the half-toning process. Such methods may dither or quantize input pixel values, including those input pixel values that are crushed to a value of zero. These methods than may determine a quantization error for each input pixel value, and may diffuse the quantization error by distributing the quantization error to neighboring pixels. By distributing the quantization error for crushed pixels, the overall intensity of a local area may be maintained. The quantization error may also be clipped before being distributed. In some implementations, the quantization error may not be distributed to crushed pixels.

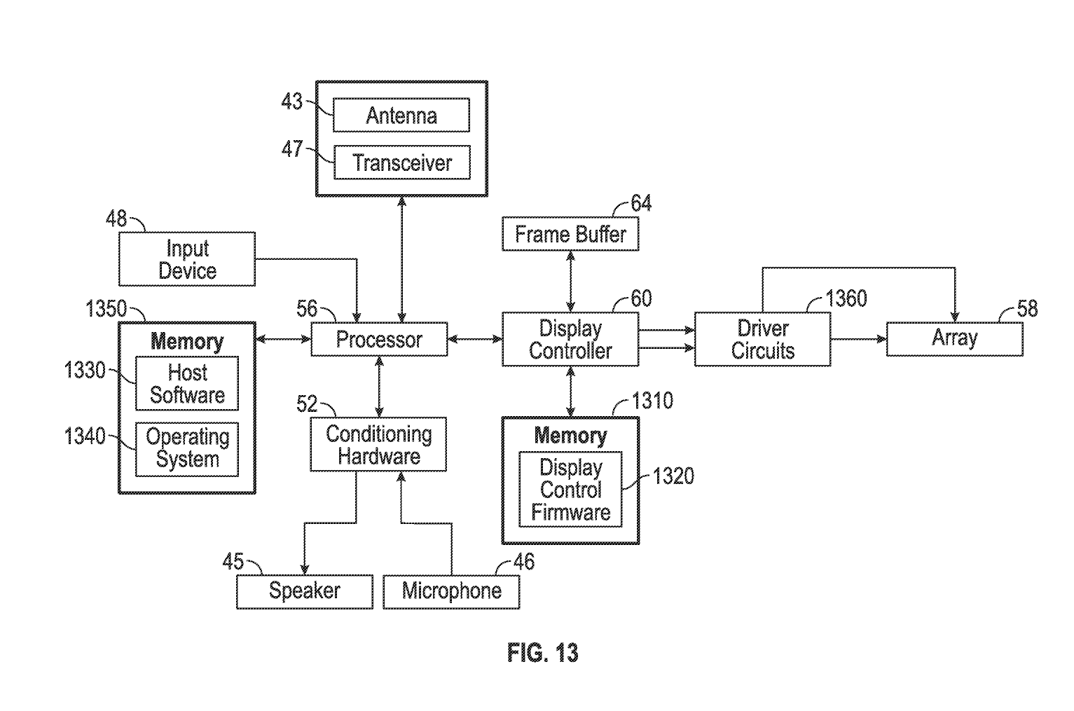

FIG. 13 is a block diagram illustrating one implementation of an apparatus for rendering an image on an electronic display. The apparatus includes a processor 56 in communication with a memory 1350. The memory 1350 includes host software 1330 and an operating system 1340. The processor 56 may receive input from an input device 48, and may also be in communication with a display controller 60. Display controller 60 is in communication with a frame buffer 64 and a memory 1310. The memory 1310 may include display control firmware 1320.

In some implementations, instructions within the operating system 1340 manage the resources of the apparatus to accomplish apparatus functions. For example, the operating system 1340 may manage resources such as a speaker 45 and a microphone 46 via conditioning hardware 52, as well as an antenna 43 and a transceiver 47. The operating system 1340 may also include display device drivers that manage an electronic display, such as a display controlled by a display controller 60. The display controller 60 may be configured to send data to driver circuits 1360, which may write data to an array of display elements 58. A display device driver within operating system 1340 may include instructions that render an image on an electronic display, which may include the array 58, the driver circuits 1360, and the display controller 60.

Operating system 1340 may further include instructions that configure the processor 56 to receive an input image including a plurality of pixels. Therefore, instructions within operating system 1340 may represent one way to receive an input image including a plurality of pixels.

Instructions within operating system 1340 may also configure processor 56 to dither at least a portion of the input pixels. Therefore, instructions within operating system 1340 represent one way for dithering at least a portion of the input pixels. In some implementations, the instructions within operating system 1340 may configure processor 56 to quantize the plurality of input pixels. Therefore, instructions within operating system 1340 represent one way of quantizing the plurality of input pixels. Instructions within operating system 1340 may also configure processor 56 to set half-tone image pixels corresponding to the portion of the input pixels that are below a crush threshold to a crushed value. Therefore, instructions within operating system 1340 represent one way of setting half-tone image pixels corresponding to the portion of the input pixels that are below a crush threshold to a crushed value.

Instructions within operating system 1340 may also configure the processor 56 to diffuse a quantization error resulting from the quantizing to half-tone image pixels other than the portion of pixels below a crush threshold as described above. Accordingly, instructions within operating system 1340 represent one way of diffusing quantization error resulting from the quantizing to half-tone image pixels other than the portion. Instructions within the operating system 1340, when executed by the processor 56, may also cause the processor 56 to output the half-tone image pixels to an output device. Therefore, instructions within the operating system 1340 represent one way of outputting the half-tone image pixels to an output device.

In other implementations, the functions described above as included in the operating system 1340 may instead be included in the host software 1330, illustrated in FIG. 13. Alternatively, these functions may instead be implemented by instructions included in display control firmware 1320. In still other implementations, these functions may be implemented in special purpose circuits. One having ordinary skill in the art would recognize other implementations may vary from the block diagram of FIG. 13 without departing from the spirit of the methods disclosed.

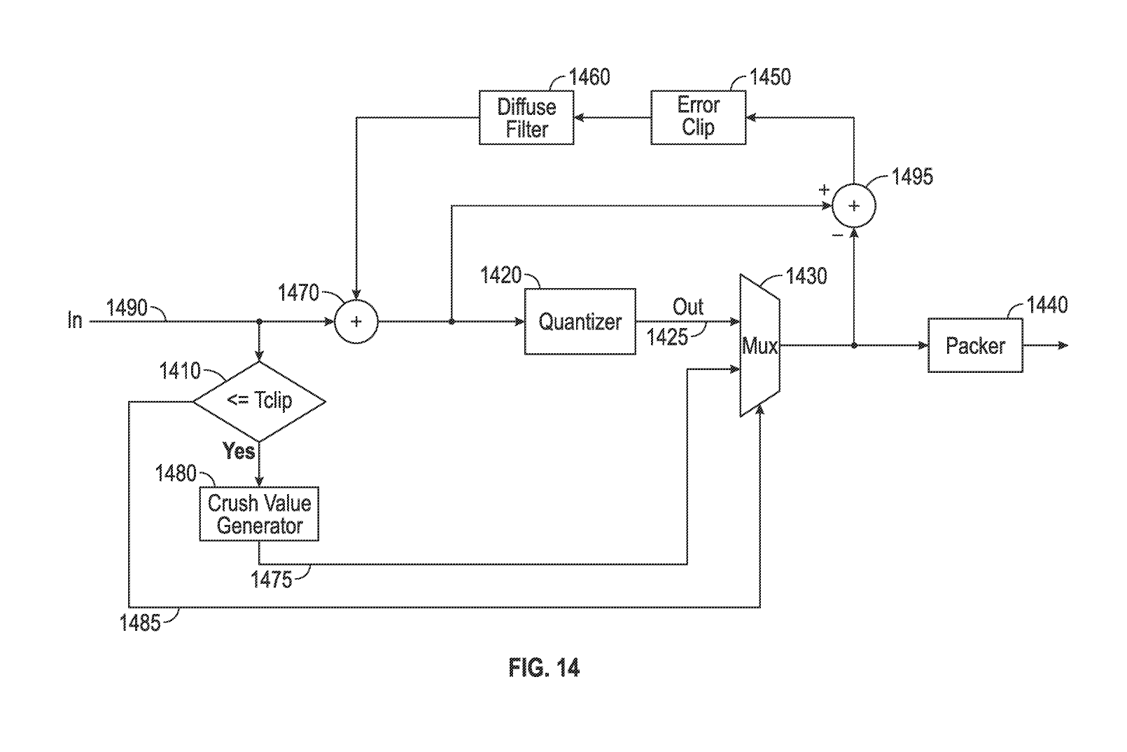

FIG. 14 is a schematic of a flow diagram illustrating one implementation of a method for rendering an image. Other implementations that embody the same method but having different configurations are also contemplated, such that the method should not be viewed as being limited in any way by the example implementation illustrated in FIG. 14. On the left side of FIG. 14, an input pixel value is received on line 1490. A decision block 1410 evaluates whether the input pixel value is below a crush threshold, Tclip. If the input pixel value is below the crush threshold Tclip, block 1480 generates a crush value. In the illustrated implementation, the crush value is zero. Crush value signal 1475 is provided to a multiplexer (mux) 1430. In some implementations, the crush value signal may be zero. In other implementations, block 1480 may generate any other non-zero value. Decision block 1410 also sets a control line 1485 based on whether the pixel value 1490 is below the threshold. The control line 1485 controls whether the mux 1430 outputs the value on line 1475 or line 1430. If the pixel value 1490 is below the threshold Tclip, mux 1430 outputs the value of line 1475 (a crush value). In the pixel value on line 1490 is above the threshold Tclip, mux 1430 outputs the value of line 1425.

The flow diagram of FIG. 14 also illustrates that an error value from a diffusion filter 1460 is added to the input pixel value on line 1490 by adder 1470, and the result is provided to a quantizer 1420. The quantizer 1420 quantizes the adjusted input pixel value and produces a result on line 1425. If the pixel value 1490 is greater than the threshold Tclip, then the mux 1430 outputs the quantized value 1425 based on a control signal from decision block 1410.

In the implementation of FIG. 14, a quantization error is determined by adder 1495, and provided to an error clipper 1450. Output from the error clipper 1450 is then provided to the diffusion filter 1460 discussed above.

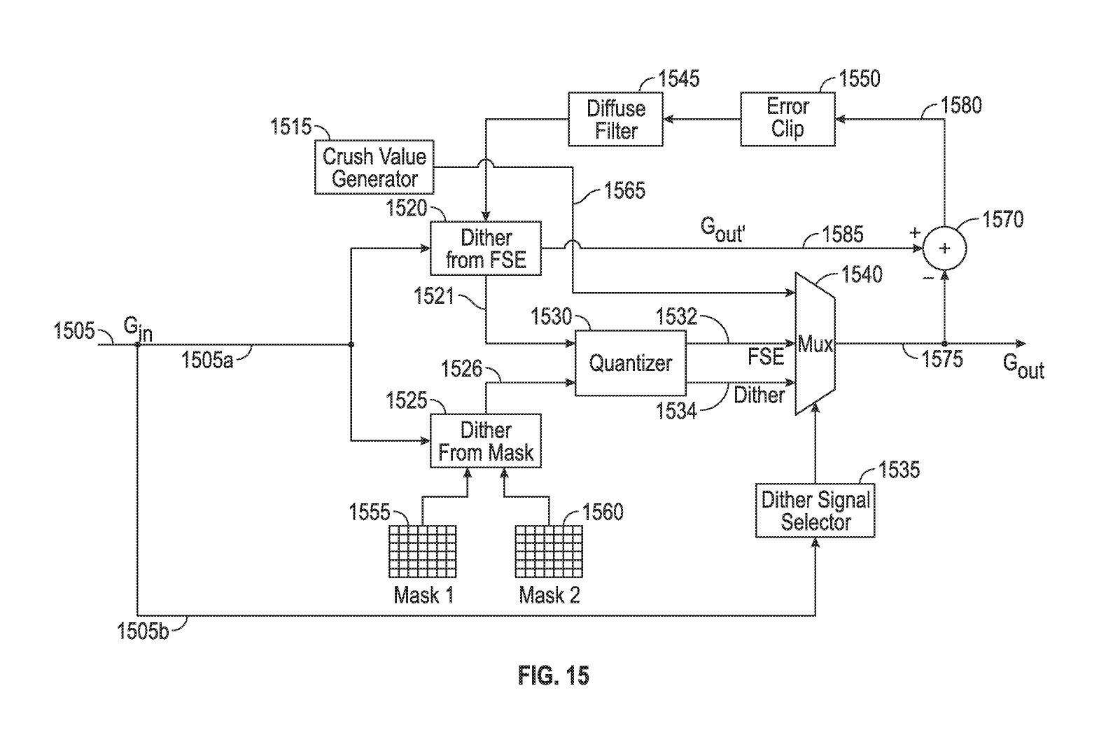

While the implementation of FIG. 14 shows a proposed method in use with a traditional Floyd Steinberg error diffusion process, other implementations may utilize other half-toning methods. For example, mask based error diffusion may also be utilized with the proposed methods and apparatus. Stevenson Arce dithering may also be used in block 1420 in some implementations. As shown in FIG. 15 below, a method utilizing both mask based and Floyd-Steinberg Error diffusion (FSE) based error diffusion may also be used in some implementations.

FIG. 15 is a flow diagram illustrating an example of one implementation of a method for rendering an image. On the left side of the flow diagram of FIG. 15, an input pixel value is received on input line 1505. The input pixel value is routed to blocks 1520 and 1525 over line 1505a. Block 1520 performs Floyd Steinberg error diffusion on the input pixel value. Other error diffusion processes are also contemplated. For example, Stevenson Arce dithering may also be implemented in block 1520 in some implementations. Block 1525 performs mask based dithering on the pixel value. Mask based dithering may add noise to the input pixel value. In other implementations, noise may be added to the input pixel value in block 1525 without using a mask. For example, random number generators may be used to randomize a noise value added to an input pixel value in block 1525 in some implementations.

Still referring to FIG. 15, results of the Floyd Steinberg error diffusion from block 1520 and the results of the mask based dithering in block 1525 are sent to quantizer 1530 over lines 1521 and 1526 respectively. Quantizer 1530 quantizes the pixel values received and provides the quantized pixel values results as inputs to the multiplexor 1540 over lines 1532 (FSE) and 1534 (mask based dithering).

The input pixel value on line 1505 is also routed to a dither signal selector 1535 over line 1505b, as illustrated in FIG. 15. Multiplexor 1540 selects one of the results of Floyd Steinberg Error diffusion (line 1532), mask based dithering (line 1534), or a zero value generated by crush value generator 1515 (line 1565) as an output to assert on line 1575. The selection is based on a signal received from the dither signal selector block 1535. In one implementation, mux 1540 may select the value generated by block 1515 as an output for line 1575 if the input pixel value on line 1505b is below a crush threshold. The value asserted on line 1575 may determine the value of a half-tone image pixel value corresponding to the input pixel value on line 1505.

As illustrated in FIG. 15, if the input value on line 1505b is above the crush threshold, dither signal selector 1535 may control the mux 1540 to select one of either the value generated by mask based dithering (line 1532) or the Floyd Steinberg error diffusion (line 1534). For example, either line 1532 or line 1534 may be selected based on whether the input pixel value on line 1505b is within a particular tonal range. In another implementation, either line 1532 or line 1534 may be selected based on a quantization error resulting from the quantization performed by block 1520. In some implementations, selection of line 1532 or line 1534 may be based on an edge strength measurement of a pixel region associated with the input pixel value asserted on line 1505.

In the illustrated implementation of FIG. 15, the results of the Floyd Steinberg error diffusion performed by block 1520 are asserted over line 1585 and provided as input to an adder 1570. The adder 1570 determines a quantization error based on the difference between output signal 1575 of mux 1540 and the results of the Floyd Steinberg error diffusion performed by block 1520. The error may be clipped by block 1550 and processed by a diffusion filter 1545. The results of the diffusion filter are then provided to the Floyd Steinberg error diffusion process performed by block 1520. The block 1520 may diffuse the error from diffusion filter 1545 to one or more additional input pixel values asserted on line 1505.

In the implementation illustrated in FIG. 15, process 1500 determines diffusion error resulting from each input pixel, including those input pixels where the output of block 1520 is not selected for assertion on output line 1575. For example, if an input pixel is crushed, resulting in the output of crush value generator block 1515 being selected for output line 1575 by the mux 1540, a quantization error is determined by adder 1570 based on the output of block 1520 and the crush value. Since this quantization error determined by adder 1570 is recaptured by block 1520, the overall intensity of the image may be preserved, as the error is eventually redistributed to other non-crushed pixels. This may provide an improvement in visual appearance when compared to the prior art methods described above.

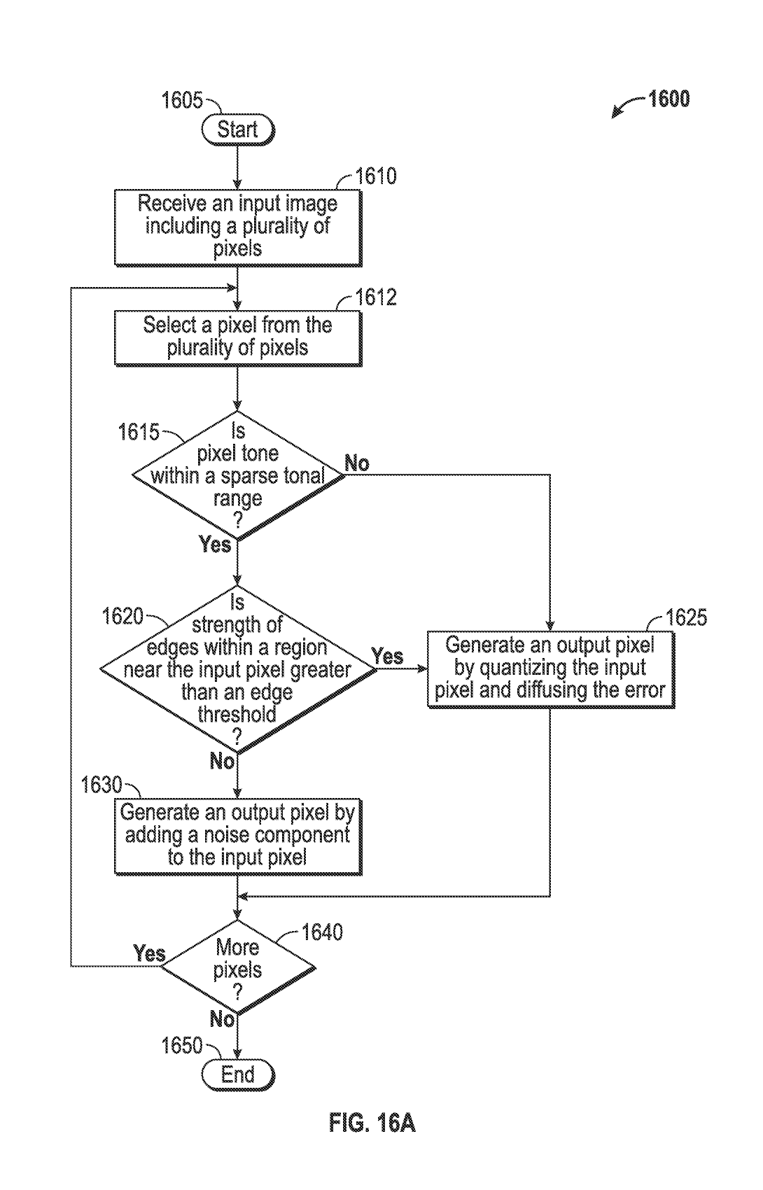

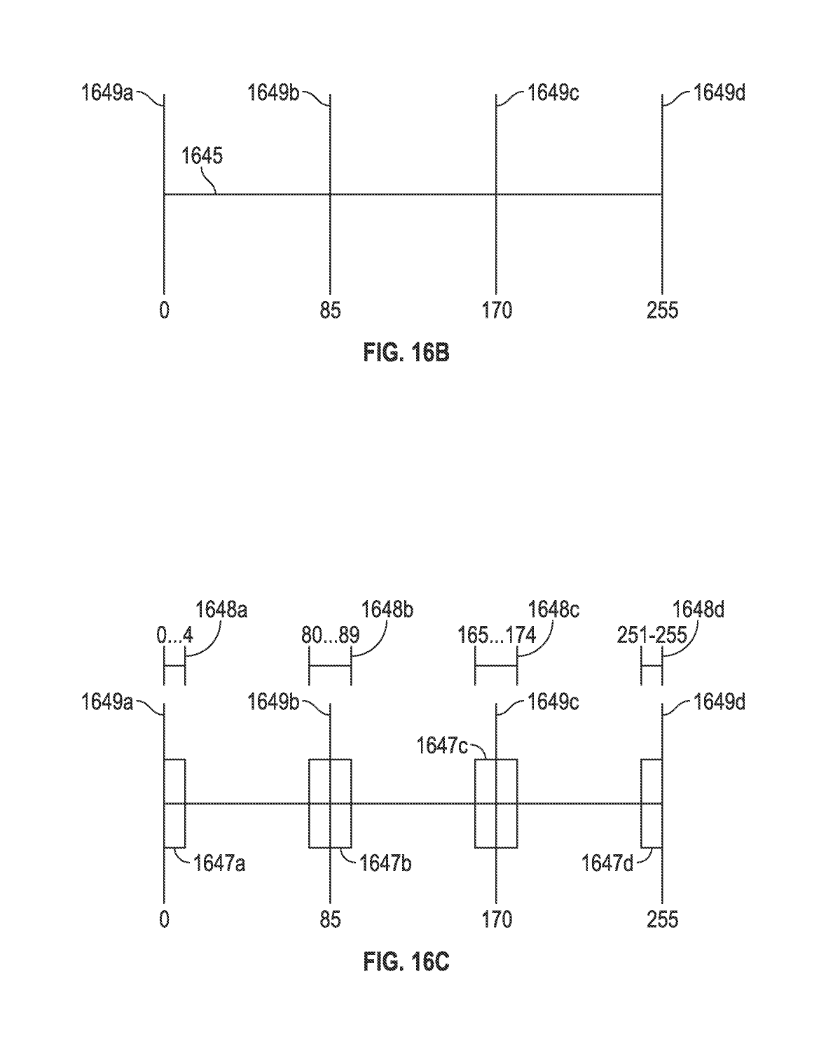

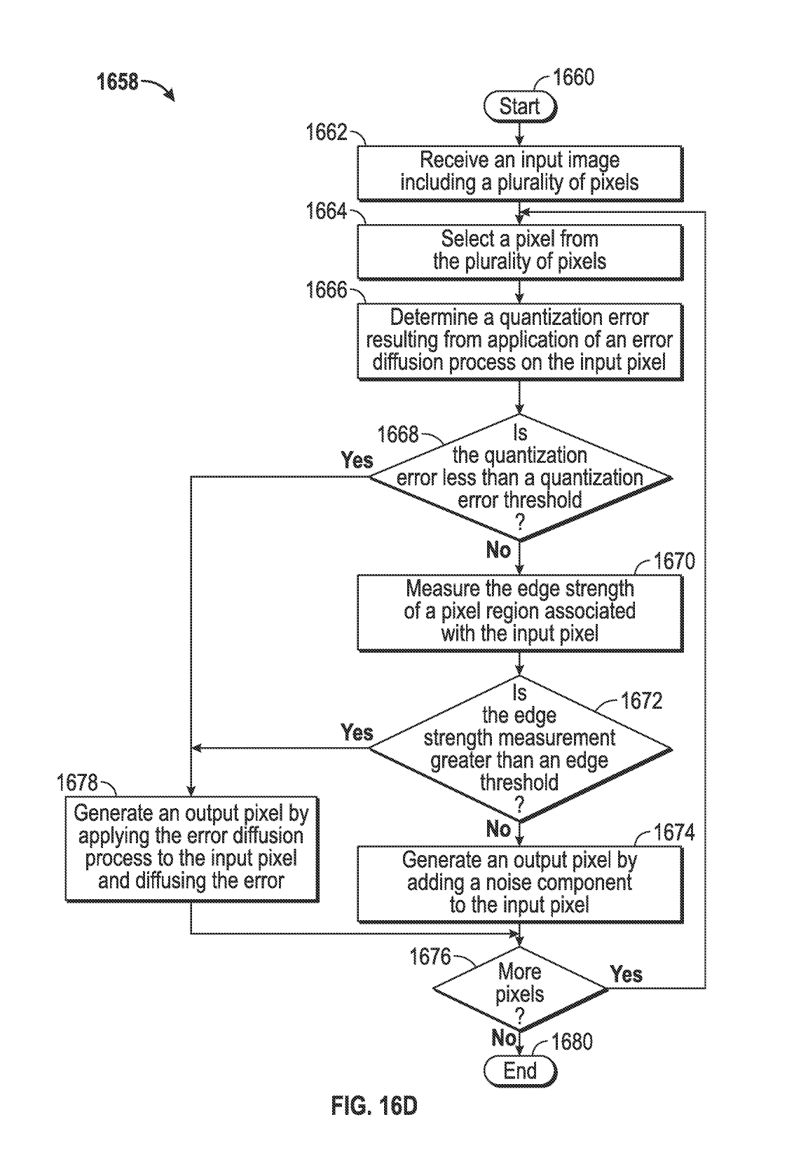

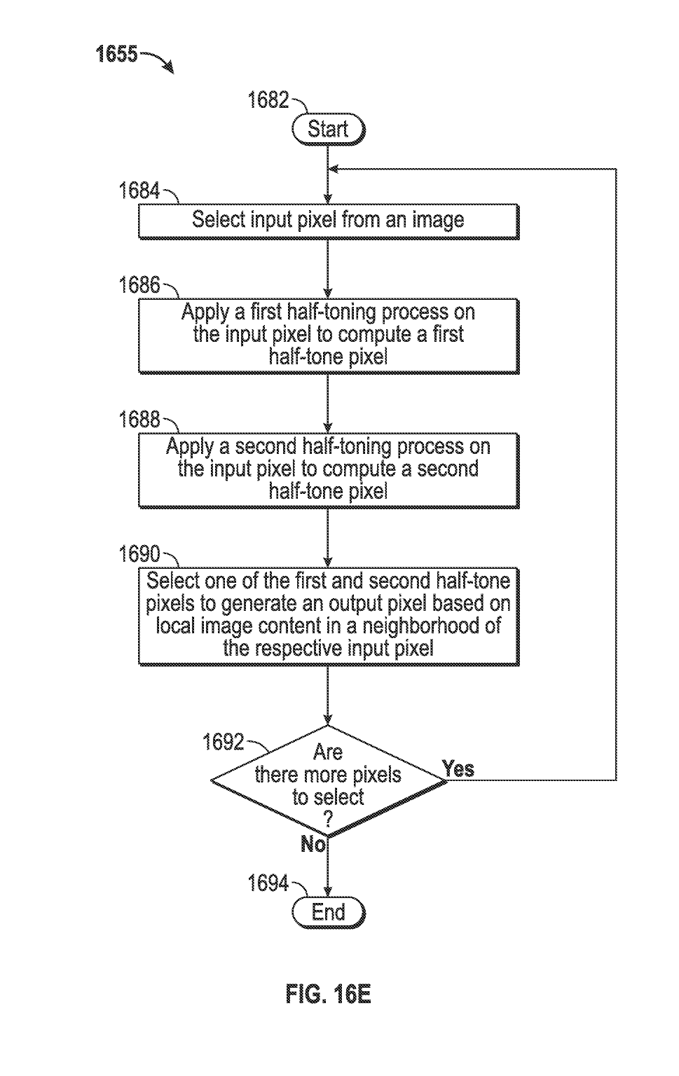

FIG. 16A is a flowchart of one implementation of a method for rendering an image. Process 1600 may be performed in one implementation by instructions contained in operating system module 1340, host software module 1330, display controller 60, or display control firmware module 1320 of FIG. 13. Process 1600 begins at start block 1605 and then moves to block 1610, where an input image is received that includes a plurality of pixels. Block 1610 may be implemented by instructions included in, for example, the host software module 1330, operating system 1340, display control firmware 1320, or display controller 60 of FIG. 13. The input image may be received, in some implementations from the input device 48 of FIG. 13. Therefore, instructions included in host software module 1330, operating system 1340, display control firmware 1320, or display controller 60, executing on a processor, such as processor 56 in FIG. 13, may represent one way to receive an input image including a plurality of input pixels.

Process 1600 then moves to block 1612, where a pixel is selected from the plurality of pixels. Process 1600 then moves to block 1615, where it determines whether a particular input pixel's tone is within a sparse tonal range. Sparse tone-levels are susceptible to worm artifacts with FSE. A tonal range may determine whether a pixel is within a sparse tonal range. If the tone of the pixel is within the sparse tonal range, then the pixel is considered to have a sparse tone. Otherwise the pixel is considered to have a non-sparse tone.

The sparseness of a pixel may represent the proximity of the pixel's tonal value to a quantization level. A first pixel may have a value that is a first distance from a quantization level. This first pixel may have a sparser tone than a second pixel having a value further from a quantization level than the first pixel's value.

FIG. 16B illustrates how an eight (8) bit pixel value range 1645 may be quantized into two bpp using four quantization levels 1649a-d. As shown, the pixel values after quantization will represent tonal values of 0 (0x00), 85 (0x01), 170 (0x10), and 255 (0x11). The relative closeness of a particular input pixel's tonal value to any of these quantization levels corresponds to the sparseness of the half tone pattern used to dither this value.

FIG. 16C illustrates sparse zones 1647a-d defined around each quantization level of an 8 bpp image. The size or width of the sparse zones may be determined based on a percentage of the bit depth of the image being quantized. For example, an eight (8) bpp image has a maximum value of 255. A percentage of this value may be used to define the size or width of the sparse zone around each quantization level. For example, one implementation may choose to define a sparse zone with a width equal to about four (4) percent of the maximum pixel value. In the case of an eight (8) bpp image, four percent of the maximum value of an eight bit pixel (255) is approximately ten (10).

In some implementations, the sparse zones define a range of input pixel values extending from each quantization level. In the example above, a sparse zone of ten (10) pixels may define sparse zones extending 10/2 or five pixel values from each quantization level and in each direction. With two bpp quantization, the sparse zones would then be defined as illustrated in FIG. 16C, items 1648a-d. FIG. 16C shows ten pixel wide ranges surrounding quantization levels 1649b and 1649c, corresponding to quantization values 85 and 170. Because quantization levels 1649a (representing a value of zero (0)) and 1649d (representing a value of 255) bound the pixel range, the sparse region extends from one side of these quantization levels. Other implementations may choose to define a sparse zone as 2, 3, 5, 6, 7, 8, or 9 percent of the maximum pixel value.

When quantizing to one bpp, a different percentage of the maximum pixel value may be used. For example, the sparse zone of a one bpp quantization may include a higher percentage of the maximum pixel value than a sparse zone of a two bpp quantization. Quantization of larger bit depth images may use percentages of maximum pixel values that are similar to the percentages used for eight (8) bpp images. For example, a 16 bit image quantized into two bpp may select a tonal range that is four (4) percent of its maximum pixel value. In this example, this represents a tonal range of 1310 pixel values. Generally, these ranges would extend 1310/2 or 655 pixel values from each quantization level and in each direction.

Returning to the discussion of FIG. 16A and decision block 1615, if the tone of the input pixel is not within a sparse tonal range, then the pixel is less susceptible to the artifacts associated with traditional error diffusion. Process 1600 then moves to processing block 1625, where an output pixel is generated by quantizing the input pixel and diffusing the error. Block 1625 may also be implemented by instructions included in the host software 1330, operating system 1340, display control firmware 1320, or display controller 60, illustrated in FIG. 13. Therefore, these instructions, executing on a processor such as processor 56 in FIG. 13 represent one way to generate an output pixel by quantizing the input pixel and diffusing the error.

If the input pixel is within the sparse tonal range, then the pixel may be susceptible to error diffusion artifacts. To further understand the nature of the input pixel when it is in a sparse tonal range, process 1600 moves from decision block 1615 to decision block 1620, where the strength of the edges within a region near the input pixel is measured and compared to an edge threshold. The region near or associated with the input pixel may be a group of at least four contiguous or non-contiguous pixels. A region near an input pixel may also be associated with the input pixel by the methods disclosed. For example, the methods disclosed may determine how to dither the input pixel based, at least in part, on the values of a group of at least four pixels. These pixel values may also be within the region near or associated with the input pixel.

If the strength measurement of the edges within the region is greater than the edge threshold, the region around the input pixel is characterized as sufficiently non-uniform. In some implementations, the strength of the edges may be measured based, at least in part, on the output of a Laplacian filter. For example, a 3×3 Laplacian filter may be used. Other Laplacian filter sizes may also be used, for example, 5×5, 7×7, and 9×9 filters may be used. If the output of the filter is above an edge threshold, the pixel region or group considered by the Laplacian filter is considered to include edge components sufficient to avoid image artifacts if error diffusion is used.

Tables 1, 2, and 3 below show some examples of Laplacian filters that may be used to determine the strength of edge components of a region or group of pixels of an image in some implementations.

TABLE 2

| | | |
|---|---|---|
| 0 | 1 | 0 |
| 1 | −4 | 1 |
| 0 | 1 | 0 |

TABLE 1

| | | |
|---|---|---|
| 1 | 1 | 1 |
| 1 | −8 | 1 |
| 1 | 1 | 1 |

TABLE 3

| | | |
|---|---|---|
| .5 | 1 | .5 |
| 1 | −6 | 1 |
| .5 | 1 | .5 |

An edge threshold for these filters may be determined based on the maximum absolute value of the filters. For purposes of illustration, we assume an implementation utilizing eight (8) bpp, with black pixels represented by a value of 255 and white pixels represented by a value of zero (0). In this implementation, if a 3×3 region consists of white pixels with one black pixel in the center position, the filter of Table 2 for example will produce its maximum value. That maximum value will be 4*255 or 1020.

Some implementations may choose an edge threshold that is a percentage of the maximum value of the filter. For example, the threshold may be set to four (4), five (5), six (6), seven (7), or eight (8) percent of the maximum value of the filter. In an implementation utilizing the Laplacian filter of Table 2, a threshold may be set to, for example, 61.2, which is six percent of the maximum value of 1020. By increasing the threshold as a percentage of the maximum value of the filter, more error diffusion will be used for edges in the image. By reducing the threshold as a percentage of the maximum value of the filter, random noise dithering will be used in some regions that include edges that would have been dithered with FSE if the higher threshold were used. While error diffusion may sharpen edges, it may also introduce directional artifacts if applied to a region with edges. Thus, careful tuning of the edge threshold may determine the best balance between these factors.

Once decision block 1620 has determined that a measurement of the edge strength of the region is above the edge threshold, process 1600 moves to processing block 1625 and an output pixel is generated by quantizing the input pixel and diffusing the error. However, if the strength of the edges within a region near the input pixel is below the edge threshold, the region near the input pixel is sufficiently uniform so as to be susceptible to display artifacts if error diffusion is applied. Therefore, process 1600 moves to processing block 1630, where an output pixel is generated by adding a noise component to the input pixel. In some implementations, the noise component may be selected by application of a dither mask to the input pixel. In other implementations, the noise component may be chosen directly or indirectly by use of a random number generator. Block 1630 may be implemented by instructions included in the host software 1330, operating system module 1340, display control firmware 1320 or display controller 60 illustrated in FIG. 13. Therefore, these instructions executing on a processor may represent one way to generate an output pixel by dithering the input pixel by adding a noise component to the input pixel.

Process 1600 then moves from either processing block 1630 or processing block 1625 to decision block 1640. Decision block 1640 determines whether there are more pixels from the plurality of pixels received in block 1610 remaining to be processed. If there are more pixels, process 1600 returns to block 1612 and a new pixel is selected and process 1600 repeats block 1612 through block 1640. Otherwise, if there are no more pixels remaining, process 1600 then moves to end block 1650.

The size and shape of the region near the input pixel may vary by implementation. Some implementations may utilize a region that is a square with sides of three pixels by three pixels, for a total of nine pixels. The regions may be defined to be larger. For example, some implementations can use a square region with sides of five pixels by five pixels for a total of 25 pixels, while in other implementations a square region of seven pixels by seven pixels is used, for a region with a total of 49 pixels. In some implementations, only some of the pixels within the boundary of a region are considered.

Other implementations may utilize regions that are substantially circular. For example, some regions may have a radius of two, three, four, five, six, seven, eight, nine, or ten pixels. Other implementations may utilize regions that are rectangular. The longest side of the rectangle may be three, four, five, six, seven, eight, nine, or ten pixels long depending on the implementation.

Other implementations may determine the size of the region based on the size of the input image. For example, some implementations may utilize a region that includes no more than one percent of the pixel area of the input image. Other implementations may define a region that includes no more than five percent of the pixels in the input image. Some implementations may define the size of the dimensions of a square or rectangular region as a percentage of the dimensions of the input image. For example, one dimension of a rectangular region may be no more than five percent of the same dimension of the input image. Similarly, the other dimension of the rectangular region may also be no more than five percent of the corresponding dimension of the input image. Other implementations may define regions to have dimensions corresponding to a certain percentage of the corresponding dimension of the input image (e.g., 1%, 2%, 3%, 4%, 5%, etc.).

In some implementations a region that surrounds the input pixel on all sides is considered associated with or near the input pixel. In other implementations, a region that is centered on the input pixel is considered as being associated with or near the input pixel. This region may be considered to substantially surround the input pixel. For example, in a three pixel by three pixel square region, the input pixel may be centered in the square. Other implementations may not center the input pixel in the region. For example, when half-toning pixels in the vicinity of the edge of an input image, some implementations may shift the region relative to the input pixel to maintain the size of the region without shifting the region beyond the borders of the input image, or the region can be truncated so that the region does not extend past borders of the input image. Such a region may be considered to substantially surround the input pixel, even though it may not surround the pixel on all sides, especially if the pixel is located at the edge or border of an image.

In some implementations, pixels within a region associated with or near the input pixel are within a certain number of pixels from the input pixel. In some implementations, each of a plurality of pixels in the region of the input image can be within 13 pixels or less of the input pixel. Examples of such implementations include, but are not limited to, regions with a plurality of pixels within 11 pixels, 7 pixels, 5 pixels, or 3 pixels from the input pixel.

Note that the size and shape of regions associated with or near an input pixel, along with their position relative to the input pixel, may vary across multiple input pixels of an image. For example, the size and shape of the region for input pixels in the center of an input image may vary from the size and shape of a region associated with or near input pixels along the edge of the input image. Similarly, the input pixels position relative to its associated region may also vary. For example, some input pixels may be centered in their associated regions. Other input pixels may be relatively positioned at one edge of a region, for example, this may be the case with input pixels located on the edge of an input image.

FIG. 16D is a flowchart of one implementation of a method for rendering an image. Process 1658 may be performed in one implementation by instructions contained in operating system module 1340, host software module 1030, display controller 60, or display control firmware module 1320 of FIG. 13. Process 1658 begins at start block 1660. In block 1662, an input image is received. The input image includes a plurality of pixels. In block 1664, a pixel is selected from the plurality of pixels in the input image received in block 1662. In block 1666, a quantization error that would result from application of an error diffusion process on the input pixel is determined.

In some implementations, the quantization error may be determined by subtracting the pixel value from a quantization level. For example, in two bpp quantization, there may be four quantization levels as illustrated in FIG. 16C. The quantization levels are 1649a (0), 1649b (85), 1649c (170), and 1649d (255). In an implementation using these quantization levels, a quantization error may be determined in block 1666 by first calculating the absolute values of the differences between the input pixel value and each quantization level. The minimum of these absolute values may be the quantization error.

In decision block 1668, the quantization error determined in block 1666 is compared to a quantization error threshold. If the error is not less than the quantization error threshold, process 1658 moves to block 1670. In some implementations, determining whether a quantization error resulting from an application of an error diffusion process is greater than an error diffusion error threshold also determines whether the input pixel is within a sparse tonal range.

As described with respect to FIG. 16A, a sparse tonal range may extend in each direction from each quantization level. In process 1658, the quantization error threshold defines the size of the sparse tonal range. Therefore, the quantization error threshold may be based on a percentage of the input image bit depth. If, as discussed with respect to FIG. 16A, the sparse tonal range is about four (4) percent of the maximum pixel value, the sparse tonal range may be 10 pixel values. To implement a sparse tonal range of 10 pixel values around each quantization level, the quantization error threshold may be set to 5. Note that in some implementations, the quantization error is determined based on the absolute value of the difference between the input pixel value and the quantization level.

Similar to FIG. 16A, quantization to one bpp may cause the quantization error threshold to be based on a different percentage of the maximum pixel value. For example, a higher percentage may be used when compared to two bpp quantization.

In block 1670, the edge strength of a pixel region associated with the input pixel is measured. In some implementations, the pixel region associated with the input pixel may be a group of at least four contiguous or non-contiguous pixels within the image. In some other implementations, the pixel region associated with the input pixel may include pixels within a threshold distance of the input pixel. Some variations in the shape or position of regions associated with input pixels may occur. For example, a pixel located close to the edge of the image may have an associated region that is shaped so as to not extend beyond the image edge. In some implementations, these pixel regions may include additional pixels from other sides of the region to maintain an equivalent number of pixels in each pixel's associated region. In other implementations, regions associated with input pixels of the image may not all include the same number of pixels.

In some implementations, the strength of the edges may be determined based, at least in part, on the output of a Laplacian filter. For example, a 3×3 Laplacian filter may be used. Other Laplacian filter sizes may also be used, for example, 5×5, 7×7, and 9×9 filters may be used. If the output of the filter is above an edge threshold, the pixel region considered by the Laplacian filter is considered to include edge components sufficient to avoid image artifacts if error diffusion is used.

Decision block 1672 determines whether the edge strength measurement is greater than an edge threshold. If a region of pixels associated with the input pixel has strong edge components, it may not be susceptible to image artifacts caused by an error diffusion process. In this case, process 1658 transitions to processing block 1678. If the edge strength measurement is not greater than an edge threshold, the region associated with the input pixel may be susceptible to image artifacts if the pixels within the region are dithered using an error diffusion process. In this case, process 1658 transitions to block 1674 where an output pixel is generated by adding a noise component to the input pixel.

Adding a random noise component to the input pixel may be performed by dithering the input pixel with a mask. In these implementations, a dither mask may include random noise components. Depending on which element of the dither mask is applied to a particular input pixel, the noise component added to each pixel may vary. Some other implementations may generate a noise component for each pixel by use of a random number generator. The results of the random number generator may be mathematically tailored to conform to a noise profile. For example, the noise profile may replicate the noise profile that may be provided by a mask in some other implementations.

As discussed, if decision block 1668 determines that the quantization error is less than a quantization error threshold, or decision block 1672 determines that an edge strength measurement is greater than an edge threshold, then process 1658 moves to processing block 1678. In block 1678, an output pixel is generated by applying the error diffusion process to the input pixel and diffusing the error. In some implementations, the error diffusion process applied in block 1678 may utilize the quantization levels relied upon in block 1666. For example, in the two bpp example discussed above, a Floyd Steinberg error diffusion process may be applied in block 1678. Other error diffusion processes are also contemplated. For example, Stevenson Arce dithering may also be used.

Decision block 1676 determines whether more pixels are available for processing. In some implementations, all of the pixels of the input image may be processed by process 1658. In other implementations, only a portion of the pixels in the image may be processed. For example, in some implementations, pixels close to the edge of an image may not be processed by process 1658. When all appropriate pixels have been processed, process 1658 ends at end block 1680.

FIG. 16E is a flowchart of one implementation of a method for rendering an image. Process 1655 may be performed in one implementation by instructions contained in operating system module 1340, host software module 1330, display controller 60, or display control firmware module 1320 of FIG. 13. Process 1655 begins at start block 1682. In block 1684, an input pixel is selected from an image. In block 1686, a first half-toning process is applied to an input pixel to compute a first half-tone pixel. The first half-toning process may be Floyd Steinberg error diffusion in some implementations. In other implementations, the first half-toning process may be a noise based dithering process. For example, noise may be added to the input pixel by use of a dither mask in some implementations. In processing block 1688, a second half-toning process is applied to the input pixel to compute a second half-tone pixel. Similar to block 1686, the second half-toning process may be FSE or noise based dithering. In one implementation, blocks 1686 and 1688 may be implemented by instructions included in host software module 1330, operating system 1340, display controller 60, or display control firmware 1320, illustrated in FIG. 13. Therefore, these instructions, executing on a processor such as processor 56 illustrated in FIG. 13, represents one way to apply a first or second half-toning process on an input pixel to compute a half-tone pixel.

In some implementations, the first half-toning process and the second half-toning process are different. Note that although block 1688 is illustrated after block 1686, no particular order regarding applying a first and second half-tone process to generate a first and second half-tone pixel should be implied. For example, in some other implementations, block 1688 may occur before block 1686. In still other implementations, block 1686 and block 1688 may occur substantially in parallel.

In block 1690, one of the first and second half-tone pixels is selected to generate an output pixel based on local image content in a neighborhood of the respective input pixel. In some implementations, the neighborhood of the respective input pixel substantially surrounds the input pixel and includes pixels adjacent to the input pixel. In some implementations, the neighborhood of the respective input pixel includes the input pixel itself. Block 1690 may also be implemented by instructions in host software module 1330 or operating system 1340, display controller 60 or display control firmware 1320. Therefore, these instructions, executing on a processor, such as processor 56, may represent one way to select one of the first and second half-tone pixels to generate an output pixel based on local image content in a neighborhood of a respective input pixel.

In block 1692, it is determined whether there are more pixels to select from the image. If not, process 1655 moves to block 1694 and ends processing for the image. If there are more pixels, process 1655 returns to block 1684.

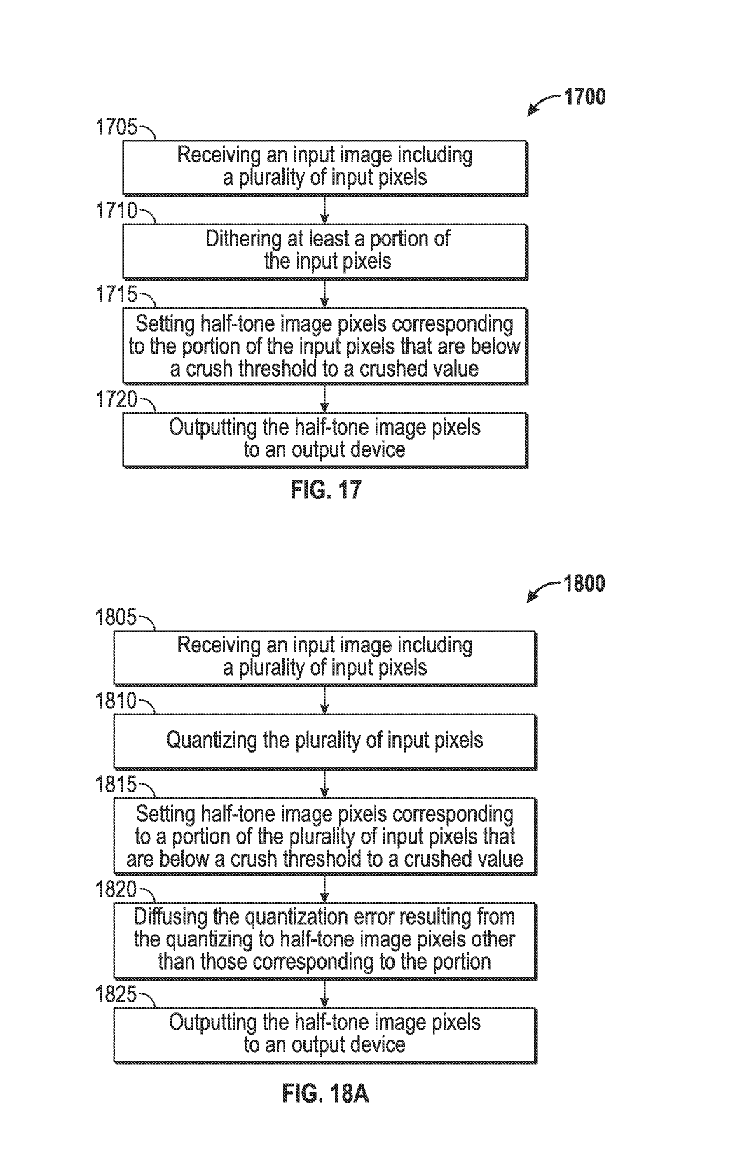

FIG. 17 is a flowchart of one implementation of a method for rendering an image. In some implementations, the method of FIG. 17 may be implemented in the display control firmware 1320 of FIG. 13. In another implementation, the method of FIG. 17 may be implemented in the display controller 60 of FIG. 13. In block 1705, an input image is received. The input image includes a plurality of input pixels. In an implementation, the input image is received from an input device. For example, the input image may be received from a network interface, or a non-volatile storage device.

In block 1710, at least a portion of the input pixels are dithered. A half-tone image including half-tone image pixels may be generated or modified based on the dithering. In an implementation, dithering may include portions of process 1600 described with respect to FIG. 16A. For example dithering may include blocks 1615, 1620, 1625, and 1630 of FIG. 16A. In another implementation, dithering may include portions of process 1658 discussed with respect to FIG. 16D. For example, dithering may include blocks 1666-1678.

In some implementations, dithering may include adding noise to the input pixel. For example, some implementations may utilize mask based dithering to distribute noise to pixels in the image. Other implementations may utilize a random noise signal to add noise to pixels of the image. In one implementation, dithering may include quantizing the input pixels. For example, a quantization process similar to that described above with respect to FIG. 16 may be used in some implementations.

Dithering may also include diffusing quantization error resulting from the quantization. Diffusing the quantization error may include distributing quantization error from a first portion of pixels to a second portion of pixels. The first and second portions may overlap. The quantization error resulting from the quantization of each pixel may be clipped before it is diffused. Some implementations may perform Floyd Steinberg error diffusion on the input pixels.

In block 1715, half-tone image pixels corresponding to a portion of the input pixels that are below a crush threshold are set to a crushed value. In some implementations, the crushed value is zero. In other implementations, the crushed value may be a non-zero value. A half-tone image pixel that corresponds to an input pixel may have the same coordinates within the half-tone image as the input pixel has in the input image. In some implementations, quantization error is not added or diffused to half-tone image pixels after they are set to a crushed value.

Some implementations may determine a crush threshold based on a dynamic range of the input pixels in the input image. The dynamic range of the input pixels may be based on the bit depth of the plurality of input pixels. Alternatively, the dynamic range of the input pixels may be based on a minimum and a maximum value of the plurality of input pixels.

Some implementations may set the crush threshold to be between four and six percent of the dynamic range of the input pixels. Some implementations may determine the crush threshold based on the input pixel bit depth. For example, an eight (8) bits per pixel (bpp) image has a maximum value of 255. A percentage of this value may be used to define the crush threshold. One implementation may determine that the crush threshold is four percent of the bit depth, or approximately ten (10) in this example. Other implementations may determine the dynamic range dynamically based on the input pixel values themselves. For example, one implementation may determine a dynamic range based on a minimum and a maximum pixel value present in an image. Some implementations may determine the dynamic range as the difference between the maximum and minimum value. The crush threshold may then be determined based on the difference between the minimum and maximum pixel value in some implementations.

Some implementations may utilize different crush thresholds for different color channels. For example, in an implementation utilizing RGB color channels, each channel may be assigned a unique crush threshold. In some implementations, only one channel may have a unique crush threshold. For example, in some implementations, a crush threshold for a green channel may be different than a crush threshold for other non-green channels. For example, the green channel crush threshold may be lower than the crush threshold for other non-green channels. In other implementations, the green channel crush threshold may be higher than the crush threshold for other non-green channels. In some implementations, only the green channel is crushed if its value is below a threshold. In these implementations, non-green channels are not crushed.

In block 1720, the half-tone image pixels are output to an output device. In an implementation, the output device may be an electronic display. Alternatively, the half-tone image pixels may be stored using a non-volatile storage device, such as a stable memory such as an SD RAM disk or a hard disk drive. In another implementation, the output device may be a network interface. In some implementations, the half-tone image is output to the output device in block 1720.

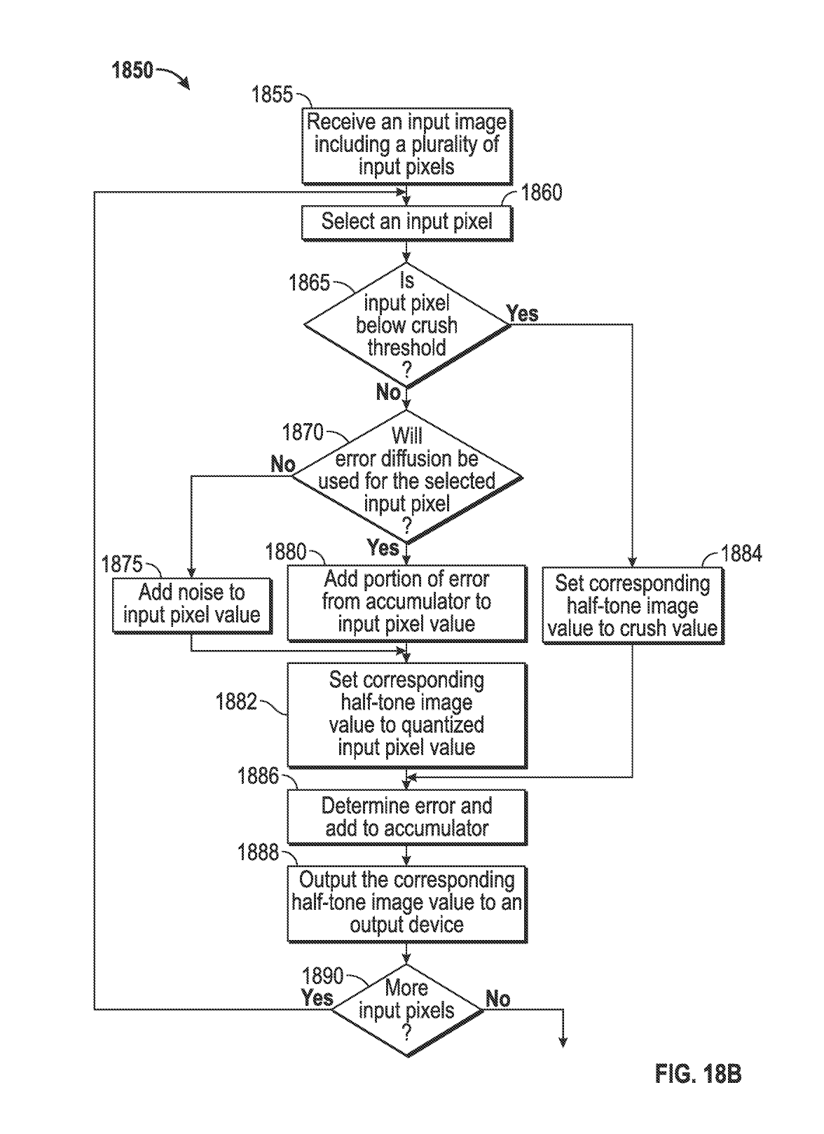

FIG. 18A is a flowchart of one implementation of a method for rendering an image. In an implementation, the method 1800 of FIG. 18 may be implemented in the display control firmware 1320 of FIG. 13. In another implementation, the method of FIG. 18 may be implemented in the display controller 60 of FIG. 13. In block 1805, an input image is received. The input image includes a plurality of input pixels. In an implementation, the input image is received from an input device. For example, the input image may be received from a network interface, or a non-volatile storage device.

In block 1810, the plurality of input pixels is quantized. For example, in one implementation, the input pixels may be quantized as described above with respect to FIG. 16B. In some implementations, Floyd Steinberg error diffusion may be used to quantize the input pixels. In these implementations, a portion of an accumulated quantization error may be added to the input pixel in block 1810. In some other implementations, noise may be added to the input pixel before it is quantized. In some implementations, block 1810 may include portions of process 1600 described with respect to FIG. 16A. For example dithering may include blocks 1615, 1620, 1625, and 1630 of FIG. 16A. In another implementation, dithering may include portions of process 1658 discussed with respect to FIG. 16D. For example, dithering may include blocks 1666-1678. For example, block 1810 may selectively add noise or quantization error to the input pixel in block 1810 based on the tone of the input pixel and/or based on an edge strength measurement of a region associated with the input pixel.

In block 1815, half-tone image pixels corresponding to a portion of the plurality of input pixels that are below a crush threshold are set to a crushed value. In some implementations, the crushed value is zero. In other implementations, the crushed value may be a non-zero value. A half-tone image pixel that corresponds to an input pixel may have the same coordinates within the half-tone image as the input pixel has in the input image. Note that in some implementations, quantizing the plurality of input pixels in block 1810 may include setting half-tone image pixels corresponding to a portion of the plurality of input pixels that are below a crush threshold to a crushed value. In other words, in some implementations, block 1815 may be incorporated into, or be a part of, block 1810.

Some implementations may determine a crush threshold based on a dynamic range of the input pixels in the input image. For example some implementations may set the crush threshold to be between four and six percent of the dynamic range of the input pixels. Some implementations may determine the crush threshold based on the input pixel bit depth. For example, an eight (8) bits per pixel (bpp) image has a maximum value of 255. A percentage of this value may be used to define the crush threshold. For example, one implementation may determine that the crush threshold is four percent of the bit depth, or approximately ten (10) in this example. Other implementations may determine the dynamic range dynamically based on the input pixel values themselves. For example, one implementation may determine a dynamic range based on a minimum and maximum pixel value present in an image. Some implementations may determine the dynamic range as the difference between the maximum and minimum value.

Some implementations may utilize different crush thresholds for different color channels. For example, in an implementation utilizing RGB color channels, each channel may be assigned a unique crush threshold. In some implementations, only one channel may have a unique crush threshold. For example, in some implementations, a crush threshold for a green channel may be different than a crush threshold for other non-green channels.

In block 1820, quantization error resulting from the quantizing in block 1810 is diffused or distributed to half-tone image pixels other than those corresponding to the portion of pixels below the crush threshold. In some implementations, no quantization error is distributed to half-tone image pixels corresponding to an input pixel that was crushed. In some of these implementations, no quantization error may be distributed to half-tone image pixels corresponding to an input pixel that was dithered using mask based dithering in block 1820. For example, if the tone of the input pixel or an edge strength measurement of the input pixel resulted in a non-error diffusion process being applied to the input pixel in block 1810, then no error may be added to the input pixel in block 1820.

In block 1825, the half-tone image pixels are output to an output device. In an implementation, the output device may be an electronic display. Alternatively, the half-tone image pixels may be stored using a non-volatile storage device, such as a stable memory such as an SD RAM disk or a hard disk drive. In another implementation, the output device may be a network interface.

FIG. 18B is a flowchart of one implementation of a method for rendering an image. In an implementation, the method 1850 of FIG. 18B may be implemented in the display control firmware 1320 of FIG. 13. In another implementation, the method of FIG. 18 may be implemented in the display controller 60 of FIG. 13. In block 1855, an input image is received. The input image includes a plurality of input pixels. In an implementation, the input image is received from an input device. For example, the input image may be received from a network interface, or a non-volatile storage device.

In block 1860, an input pixel from the plurality of pixels is selected. In block 1865, the selected input pixel is compared to a crush threshold. If the input pixel is below the crush threshold, a corresponding half-tone image pixel value is set to a crush value in block 1884. If the input pixel is above the crush threshold, block 1870 determines whether error diffusion will be used for the selected input pixel. Error diffusion may be used for the selected input pixel based on the tone of the input pixel or based on an edge strength measurement of a pixel region associated with the input pixel. In an implementation, block 1870 may implement one or more portions of process 1600 or 1658 discussed above. For example, block 1870 may determine a quantization error resulting from application of an error diffusion process on the input pixel. If the quantization error is less than a quantization error threshold, process 1850 may move to block 1880. Otherwise, block 1870 may further determine an edge strength measurement of a region of input pixels associated with the input pixel. If the edge strength measurement is greater than an edge threshold, process 1850 may move to block 1880. Note that these steps are also described with respect to blocks 1666-1672 of process 1658.

If error diffusion is not used, process 1850 moves from block 1870 to block 1875, where noise is added to the input pixel value. If error diffusion is used, a portion of quantization error from an accumulator is added to the input pixel value in block 1880. In block 1882, a half-tone image value corresponding to the input pixel is set to a quantized value of the input pixel value. For example, a quantized version of the input pixel value may be determined based on a nearest quantization interval, as discussed above with respect to FIG. 16B. Note that some implementations of process 1850 may not implement blocks 1870 and 1875. In these implementations if the input pixel is not below the crush threshold, process 1800 may move directly to block 1880 where a portion of an error from the accumulator is added to the input pixel value.

In block 1886, an error is determined and added to the accumulator. In an implementation, the error may be a difference between the corresponding half-tone image value set in blocks 1882 or 1884 and the value of the input pixel selected in block 1860. In an implementation, the error may be clipped before it is added to the accumulator. In an implementation, the accumulator may be an error diffusion filter, such as diffusion filter 1460 of FIG. 14 or diffusion filter 1545 of FIG. 15. In block 1888, the corresponding half-tone image value is output to an output device. In an implementation, an output device may be an electronic display. In another implementation, the output device may be an electronic memory. Block 1890 determines whether there are additional input pixels to select. If there are, processing returns to block 1860 to repeat the above process.

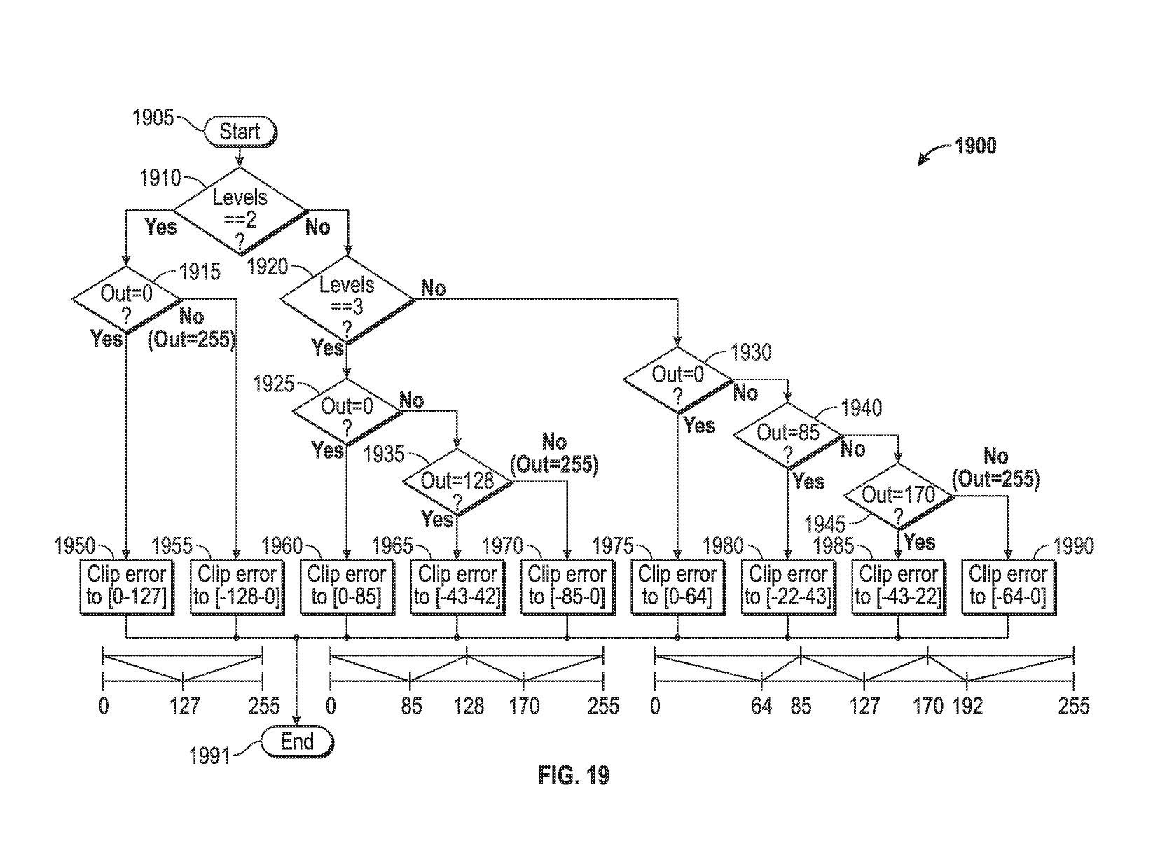

FIG. 19 shows one implementation of an error clipping scheme that supports bi-level half-toning (1 bpp output) and multi-level half-toning (2 bpp or more output). In some implementations, error clipping process 1900 may be implemented by instructions contained in operating system 1330, host program 1340, or display controller firmware 1320 illustrated in FIG. 13. The error clipping scheme illustrated in FIG. 19 may be implemented in block 1450 of FIG. 14 in some implementations. In other implementations, the error clipping scheme illustrated in FIG. 19 may be implemented in block 1550 of FIG. 15. As their name implies, blocks 1450 or 1550 clip quantization error into a desired error range. In some error diffusion methods, quantization error can be bounded. For instance, in bi-level error diffusion with an output of either 0 (black) or 1 (white) and a threshold of 0.5, the range of quantization error is bounded between −0.5 to 0.5. When the quantization error approaches these bounds in these error diffusion methods, the methods force the error to move in the opposite direction (towards the opposite threshold or bound). As explained below however, in the proposed half-toning method the quantization error may exceed these boundaries.

This effect is illustrated with an example. First, the example assumes that the current quantization error is 0.4 in bi-level half-toning. After an input pixel value is compared to a pixel crush threshold, it is further assumed that the pixel is crushed to a crushed pixel value. This may result in significantly larger quantization errors than those experienced with traditional FSE methods, where the quantization error is bounded by the bit depth of the input signal divided by the number of quantization intervals. The difference between a pixel value generated by the quantizer 1420 or quantizer 1530 and the crushed pixel value may be large. This large quantization error is then accumulated and may be added to subsequent pixels, for example if traditional FSE methods were used to distribute the error. If additional pixel values are crushed, further accumulation of quantization error may occur, resulting in severe visible artifacts such as color bleed, large pixel clusters, etc. To avoid this problem, some implementations of the disclosed half-toning methods include an error clipping process to bound the quantization error that is carried forward and distributed to subsequent input pixels. One implementation of the error clipping process is discussed below with reference to FIG. 19.

Process 1900 of FIG. 19 starts at start block 1905 and then moves to decision block 1910 where it determines whether it is clipping data generated with two quantization intervals. If process 1900 is processing data generated based on two quantization intervals, process 1900 move from decision block 1910 to decision block 1915, where the output bit is compared to zero. If the output bit is zero, process 1900 moves to processing block 1950 where the error is clipped to between 0 and 127. If the output bit is not zero, process 1900 moves to processing block 1955, where the error is clipped to between −128 and zero (0).

Still referring to the example implementation of FIG. 19, if process 1900 is not processing data generated based on two quantization intervals, process 1900 moves to decision block 1920 and determines if it is processing data generated based on three quantization intervals. If it is processing data based on three quantization intervals, process 1900 moves to decision block 1925 which determines whether the output is zero. If it is zero, process 1900 moves to processing block 1960, and the error is clipped to be between 0 and 85. If the output is not zero, process 1900 moves from decision block 1925 to decision block 1935, which determines whether the output is equal to 128. If the output is equal to 128, process 1900 moves to block 1965, and the error is clipped to be between −43 and 42. If the output is not equal to 128, process 1900 moves to processing block 1970, where the error is clipped to be between −85 and zero.

If decision block 1920 determines that it is not processing data generated based on three quantization intervals, process 1900 moves to decision block 1920, which determines whether the output is zero. If it is zero, process 1900 moves to block 1975 which clips the error to be between 0 and 64. If the output is not zero, process 1900 moves to decision block 1940 which determines whether the output is equal to 85. If the output is equal to 85, process 1900 moves to block 1980 which clips the error to be between −22 and 43. If the output is not equal to 85, process 1900 moves to decision block 1945, which determines whether the output is equal to 170. If the output is equal to 170, process 1900 moves to block 1985 which clips the error to be between −43 and 22. Otherwise, process 1900 moves to block 1990, which clips the error to be between −64 and zero (0). Process 1900 then moves to end state 1991. The error clipping method illustrated in FIG. 19 can be easily generalized for higher bit depths.

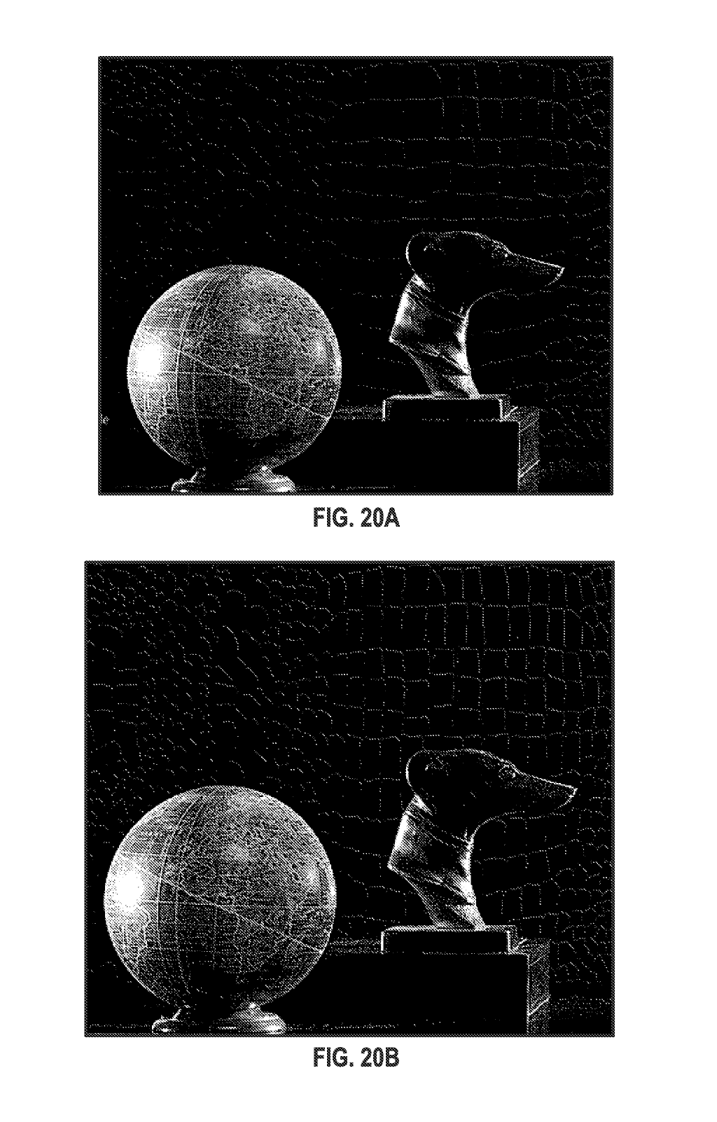

FIGS. 20A and 20B demonstrate the improvement in a half-toned image generated by some of the disclosed implementations. FIG. 20A shows a half-toned image processed with traditional crush methods. Note the artifacts that arise because pixels are crushed. Image features in dark areas are lost. For example, FIG. 20A does not show the faint white lines present in the original image shown in FIG. 12A. FIG. 20B shows an image processed with the disclosed implementations. Some image features and texture in the dark areas are retained.

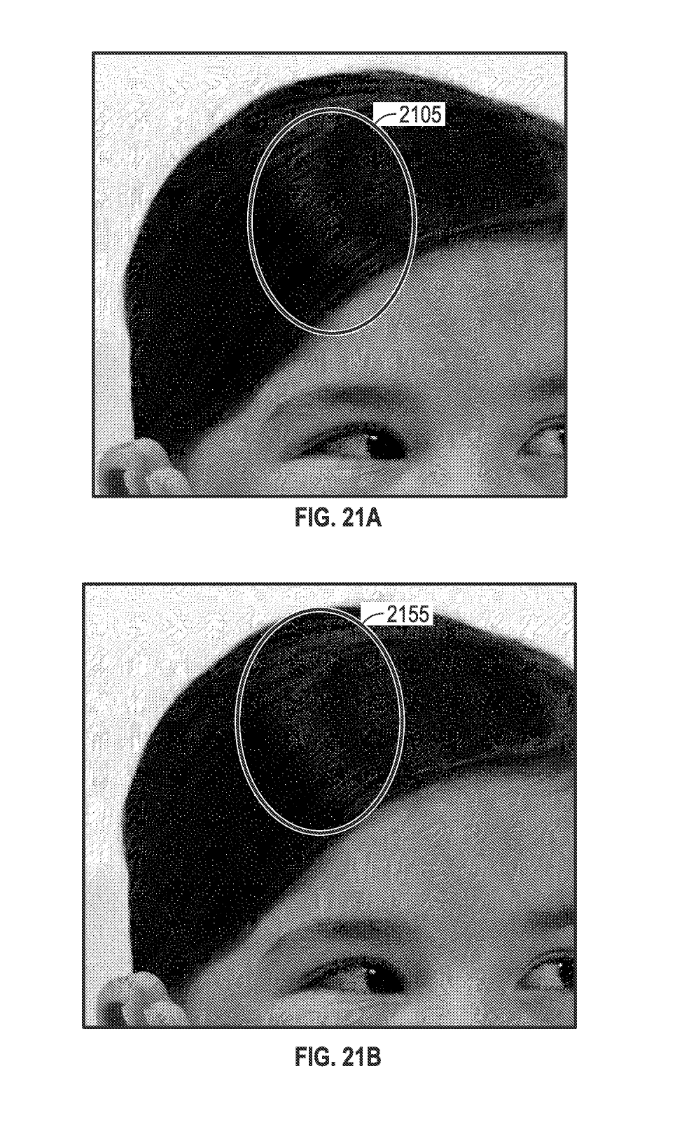

FIGS. 21A and 21B demonstrate the improvement in a half-toned image generated by some of the disclosed implementations. FIG. 21A shows a half-toned image processed with traditional crush methods. Note the artifacts that arise because pixels are crushed. Image features in dark areas are lost. For example, detail is lost within circle 2105. FIG. 21B shows an image processed with the disclosed implementations. Some image features and texture in the dark areas are retained. For example, the region encircled by circle 2155 shows more detail than the region of the image in FIG. 21A encircled by circle 2105.

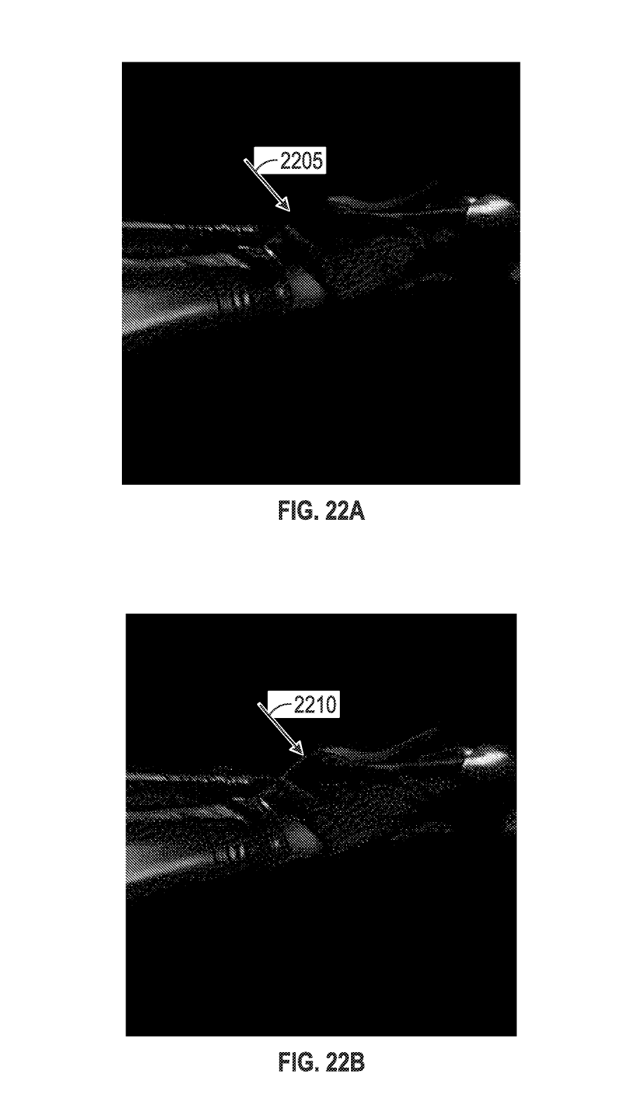

FIGS. 22A and 22B demonstrate the improvement in a half-toned image generated by some of the disclosed implementations. FIG. 22A shows a half-toned image processed with traditional crush methods. Note the artifacts that arise because pixels are crushed. Image features in dark areas are lost. FIG. 22B shows an image processed with the disclosed implementations. Some image features and texture in the dark areas are retained. For example, when compared with the area identified by arrow 2210 of FIG. 22B, the area identified by arrow 2205 in FIG. 22A has lost the faint white line that can be seen at the end of arrow 2210 in FIG. 22B.

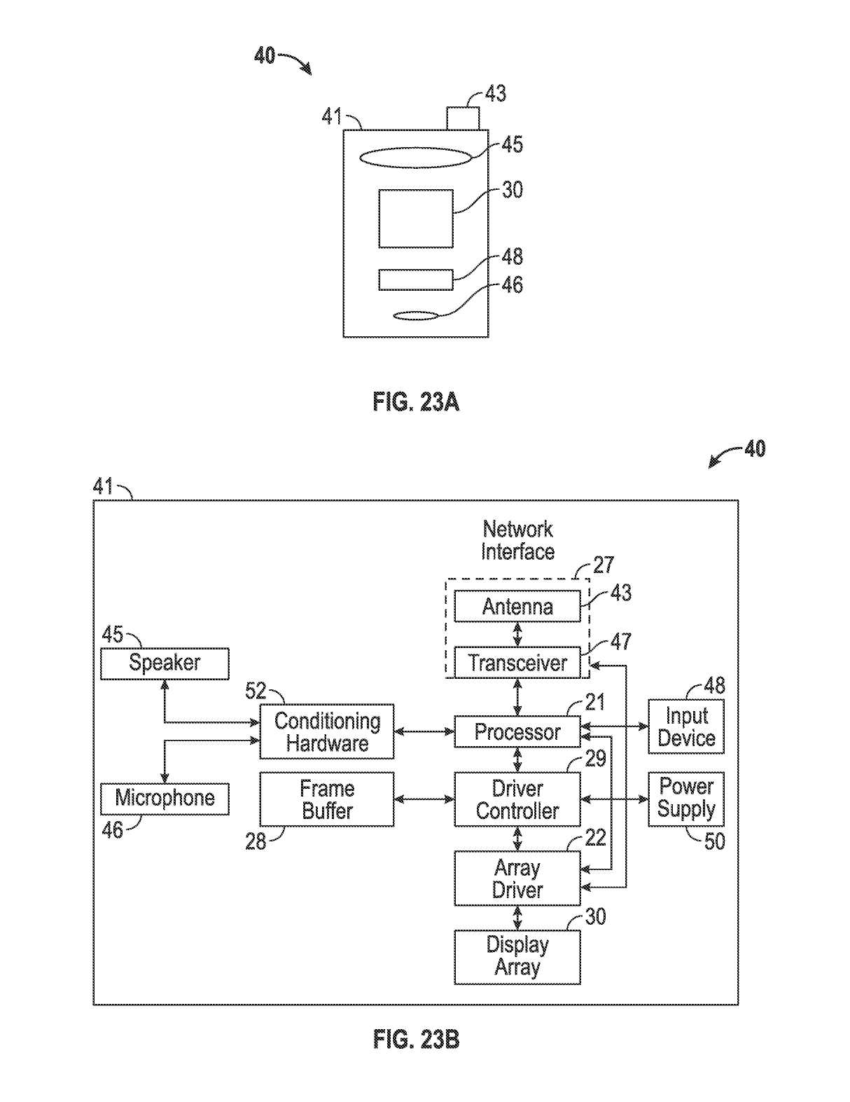

FIGS. 23A and 23B show examples of system block diagrams illustrating a display device 40 that includes a plurality of interferometric modulators. The display device 40 can be, for example, a cellular or mobile telephone. However, the same components of the display device 40 or slight variations thereof are also illustrative of various types of display devices such as televisions, e-readers and portable media players.

The display device 40 includes a housing 41, a display 30, an antenna 43, a speaker 45, an input device 48, and a microphone 46. The housing 41 can be formed from any of a variety of manufacturing processes, including injection molding, and vacuum forming. In addition, the housing 41 may be made from any of a variety of materials, including, but not limited to: plastic, metal, glass, rubber, and ceramic, or a combination thereof. The housing 41 can include removable portions (not shown) that may be interchanged with other removable portions of different color, or containing different logos, pictures, or symbols.

The display 30 may be any of a variety of displays, including a bi-stable or analog display, as described herein. The display 30 also can be configured to include a flat-panel display, such as plasma, EL, OLED, STN LCD, or TFT LCD, or a non-flat-panel display, such as a CRT or other tube device. In addition, the display 30 can include an interferometric modulator display, as described herein.

The components of the display device 40 are schematically illustrated in FIG. 23B. The display device 40 includes a housing 41 and can include additional components at least partially enclosed therein. For example, the display device 40 includes a network interface 27 that includes an antenna 43 which is coupled to a transceiver 47. The transceiver 47 is connected to a processor 21, which is connected to conditioning hardware 52. The conditioning hardware 52 may be configured to condition a signal (e.g., filter a signal). The conditioning hardware 52 is connected to a speaker 45 and a microphone 46. The processor 21 is also connected to an input device 48 and a driver controller 29. The driver controller 29 is coupled to a frame buffer 28, and to an array driver 22, which in turn is coupled to a display array 30. A power supply 50 can provide power to some or all of the components of the particular display device 40 design.

The network interface 27 includes the antenna 43 and the transceiver 47 so that the display device 40 can communicate with one or more devices over a network. The network interface 27 also may have some processing capabilities to relieve, e.g., data processing performed by the processor 21. The antenna 43 can transmit and receive signals. In some implementations, the antenna 43 transmits and receives RF signals according to the IEEE 16.11 standard, including IEEE 16.11(a), (b), or (g), or the IEEE 802.11 standard, including IEEE 802.11a, b, g or n. In some other implementations, the antenna 43 transmits and receives RF signals according to the BLUETOOTH standard. In the case of a cellular telephone, the antenna 43 is designed to receive code division multiple access (CDMA), frequency division multiple access (FDMA), time division multiple access (TDMA), Global System for Mobile communications (GSM), GSM/General Packet Radio Service (GPRS), Enhanced Data GSM Environment (EDGE), Terrestrial Trunked Radio (TETRA), Wideband-CDMA (W-CDMA), Evolution Data Optimized (EV-DO), 1xEV-DO, EV-DO Rev A, EV-DO Rev B, High Speed Packet Access (HSPA), High Speed Downlink Packet Access (HSDPA), High Speed Uplink Packet Access (HSUPA), Evolved High Speed Packet Access (HSPA+), Long Term Evolution (LTE), AMPS, or other known signals that are used to communicate within a wireless network, such as a system utilizing 3G or 4G technology. The transceiver 47 can pre-process the signals received from the antenna 43 so that they may be received by and further manipulated by the processor 21. The transceiver 47 also can process signals received from the processor 21 so that they may be transmitted from the display device 40 via the antenna 43.

In some implementations, the transceiver 47 can be replaced by a receiver. In addition, the network interface 27 can be replaced by an image source, which can store or generate image data to be sent to the processor 21. The processor 21 can control the overall operation of the display device 40. The processor 21 receives data, such as compressed image data from the network interface 27 or an image source, and processes the data into raw image data or into a format that is readily processed into raw image data. The processor 21 can send the processed data to the driver controller 29 or to the frame buffer 28 for storage. Raw data typically refers to the information that identifies the image characteristics at each location within an image. For example, such image characteristics can include color, saturation, and gray-scale level.

The processor 21 can include a microcontroller, CPU, or logic unit to control operation of the display device 40. The conditioning hardware 52 may include amplifiers and filters for transmitting signals to the speaker 45, and for receiving signals from the microphone 46. The conditioning hardware 52 may be discrete components within the display device 40, or may be incorporated within the processor 21 or other components.

The driver controller 29 can take the raw image data generated by the processor 21 either directly from the processor 21 or from the frame buffer 28 and can re-format the raw image data appropriately for high speed transmission to the array driver 22. In some implementations, the driver controller 29 can re-format the raw image data into a data flow having a raster-like format, such that it has a time order suitable for scanning across the display array 30. Then the driver controller 29 sends the formatted information to the array driver 22. Although a driver controller 29, such as an LCD controller, is often associated with the system processor 21 as a stand-alone Integrated Circuit (IC), such controllers may be implemented in many ways. For example, controllers may be embedded in the processor 21 as hardware, embedded in the processor 21 as software, or fully integrated in hardware with the array driver 22.

The array driver 22 can receive the formatted information from the driver controller 29 and can re-format the video data into a parallel set of waveforms that are applied many times per second to the hundreds, and sometimes thousands (or more), of leads coming from the display's x-y matrix of pixels.

In some implementations, the driver controller 29, the array driver 22, and the display array 30 are appropriate for any of the types of displays described herein. For example, the driver controller 29 can be a conventional display controller or a bi-stable display controller (e.g., an IMOD controller). Additionally, the array driver 22 can be a conventional driver or a bi-stable display driver (e.g., an IMOD display driver). Moreover, the display array 30 can be a conventional display array or a bi-stable display array (e.g., a display including an array of IMODs). In some implementations, the driver controller 29 can be integrated with the array driver 22. Such an implementation is common in highly integrated systems such as cellular phones, watches and other small-area displays.

In some implementations, the input device 48 can be configured to allow, e.g., a user to control the operation of the display device 40. The input device 48 can include a keypad, such as a QWERTY keyboard or a telephone keypad, a button, a switch, a rocker, a touch-sensitive screen, or a pressure- or heat-sensitive membrane. The microphone 46 can be configured as an input device for the display device 40. In some implementations, voice commands through the microphone 46 can be used for controlling operations of the display device 40.

The power supply 50 can include a variety of energy storage devices as are well known in the art. For example, the power supply 50 can be a rechargeable battery, such as a nickel-cadmium battery or a lithium-ion battery. The power supply 50 also can be a renewable energy source, a capacitor, or a solar cell, including a plastic solar cell or solar-cell paint. The power supply 50 also can be configured to receive power from a wall outlet.

In some implementations, control programmability resides in the driver controller 29 which can be located in several places in the electronic display system. In some other implementations, control programmability resides in the array driver 22. The above-described optimization may be implemented in any number of hardware and/or software components and in various configurations.

The various illustrative logics, logical blocks, modules, circuits and algorithm steps described in connection with the implementations disclosed herein may be implemented as electronic hardware, computer software, or combinations of both. The interchangeability of hardware and software has been described generally, in terms of functionality, and illustrated in the various illustrative components, blocks, modules, circuits and steps described above. Whether such functionality is implemented in hardware or software depends upon the particular application and design constraints imposed on the overall system.

The hardware and data processing apparatus used to implement the various illustrative logics, logical blocks, modules and circuits described in connection with the aspects disclosed herein may be implemented or performed with a general purpose single- or multi-chip processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A general purpose processor may be a microprocessor, or, any conventional processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration. In some implementations, particular steps and methods may be performed by circuitry that is specific to a given function.

In one or more aspects, the functions described may be implemented in hardware, digital electronic circuitry, computer software, firmware, including the structures disclosed in this specification and their structural equivalents thereof, or in any combination thereof. Implementations of the subject matter described in this specification also can be implemented as one or more computer programs, i.e., one or more modules of computer program instructions, encoded on a computer storage media for execution by, or to control the operation of, data processing apparatus.

If implemented in software, the functions may be stored on or transmitted over as one or more instructions or code on a computer-readable medium. The steps of a method or algorithm disclosed herein may be implemented in a processor-executable software module which may reside on a computer-readable medium. Computer-readable media includes both computer storage media and communication media including any medium that can be enabled to transfer a computer program from one place to another. A storage media may be any available media that may be accessed by a computer. By way of example, and not limitation, such computer-readable media may include RAM, ROM, EEPROM, CD-ROM or other optical disk storage, magnetic disk storage or other magnetic storage devices, or any other medium that may be used to store desired program code in the form of instructions or data structures and that may be accessed by a computer. Also, any connection can be properly termed a computer-readable medium. Disk and disc, as used herein, includes compact disc (CD), laser disc, optical disc, digital versatile disc (DVD), floppy disk, and blu-ray disc where disks usually reproduce data magnetically, while discs reproduce data optically with lasers. Combinations of the above should also be included within the scope of computer-readable media. Additionally, the operations of a method or algorithm may reside as one or any combination or set of codes and instructions on a machine readable medium and computer-readable medium, which may be incorporated into a computer program product.

Various modifications to the implementations described in this disclosure may be readily apparent to those skilled in the art, and the generic principles defined herein may be applied to other implementations without departing from the spirit or scope of this disclosure. Thus, the claims are not intended to be limited to the implementations shown herein, but are to be accorded the widest scope consistent with this disclosure, the principles and the novel features disclosed herein. The word “exemplary” is used exclusively herein to mean “serving as an example, instance, or illustration.” Any implementation described herein as “exemplary” is not necessarily to be construed as preferred or advantageous over other implementations. Additionally, a person having ordinary skill in the art will readily appreciate, the terms “upper” and “lower” are sometimes used for ease of describing the figures, and indicate relative positions corresponding to the orientation of the figure on a properly oriented page, and may not reflect the proper orientation of the IMOD as implemented.

Certain features that are described in this specification in the context of separate implementations also can be implemented in combination in a single implementation. Conversely, various features that are described in the context of a single implementation also can be implemented in multiple implementations separately or in any suitable subcombination. Moreover, although features may be described above as acting in certain combinations and even initially claimed as such, one or more features from a claimed combination can in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. Further, the drawings may schematically depict one more example processes in the form of a flow diagram. However, other operations that are not depicted can be incorporated in the example processes that are schematically illustrated. For example, one or more additional operations can be performed before, after, simultaneously, or between any of the illustrated operations. In certain circumstances, multitasking and parallel processing may be advantageous. Moreover, the separation of various system components in the implementations described above should not be understood as requiring such separation in all implementations, and it should be understood that the described program components and systems can generally be integrated together in a single software product or packaged into multiple software products. Additionally, other implementations are within the scope of the following claims. In some cases, the actions recited in the claims can be performed in a different order and still achieve desirable results.

What is claimed is:

1. A method of rendering at least a portion of a half-tone image on a display, the method comprising:
receiving an input image including a plurality of input pixels;
dithering at least a portion of the input pixels;
setting half-tone image pixels corresponding to the portion of the input pixels that are below a crush threshold to a crushed value; and
outputting the half-tone image pixels to an output device.

2. The method of claim 1, further comprising setting half-tone image pixels corresponding to the portion of input pixels that are above the threshold based on the dithering.

3. The method of claim 1, wherein dithering includes quantizing.

4. The method of claim 3, wherein dithering further includes diffusing a quantization error.

5. The method of claim 4, wherein the portion of input pixels below the crush threshold are quantized, and at least a portion of quantization error resulting from the quantizing is diffused to half-tone image pixels.

6. The method of claim 1, wherein the output device is an electronic display.

7. The method of claim 1, wherein the input image is received from an input device.

8. The method of claim 4, further comprising clipping quantization error resulting from the quantizing before diffusing the quantization error.

9. The method of claim 1, wherein the dithering utilizes Floyd Steinberg Error Diffusion.

10. The method of claim 1, wherein the dithering adds noise to the input pixels.

11. The method of claim 1, wherein the crush threshold is between four percent and six percent of a dynamic range of a plurality of input pixels.

12. The method of claim 1, further comprising utilizing a second crush threshold for green pixels that is lower than the crush threshold, which is used for non-green pixels.

13. An electronic display displaying an image comprised of a plurality of pixel values determined based on the method of claim 1.

14. An apparatus for rendering at least a portion of a half-tone image on a display, comprising:
a processor;
a memory operably connected to the processor, the memory configured to store:
an image receiver module, configured to receive an input image including a plurality of input pixels,
a dithering module, configured to dither at least a portion of the input pixels,
a pixel crush module, configured to set half-tone image pixels corresponding to the portion of the input pixels that are below a crush threshold to a crushed value, and
an output module, configured to output the half-tone image pixels to an output device.

15. The apparatus of claim 14, wherein the dithering module is further configured to set half-tone image pixels corresponding to the portion of input pixels that are above the threshold based on the dithering.

16. The apparatus of claim 14, wherein the dithering module is further configured to quantize the portion of the input pixels.

17. The apparatus of claim 16, wherein the dithering module is further configured to diffuse a quantization error resulting from the quantizing.

18. The apparatus of claim 17, wherein the dithering module is further configured to diffuse at least a portion of the quantization error resulting from quantizing the portion of input pixels below the crush threshold to half-tone image pixels.

19. The apparatus of claim 17, further comprising an error clipping module, configured to clip quantization error resulting from the quantizing before diffusing the quantization error.

20. The apparatus of claim 14 wherein the dithering module is further configured to implement Floyd Steinberg Error Diffusion for at least a portion of the input pixels.

21. The apparatus of claim 14, wherein the dithering module is further configured to add noise to a portion of the input pixels.

22. The apparatus of claim 14, wherein the crush threshold is between four percent and six percent of a dynamic range of a plurality of input pixels.

23. The apparatus of claim 14, wherein the pixel crush module is further configured to utilize a second crush threshold for green pixels that is lower than the crush threshold, wherein the crush threshold is used for non-green pixels.

24. An apparatus for rendering at least a portion of a half-tone image on a display, comprising:
means for receiving an input image including a plurality of input pixels;
means for dithering at least a portion of the input pixels;
means for setting half-tone image pixels corresponding to the portion of the input pixels that are below a crush threshold to a crushed value; and
means for outputting the half-tone image pixels to an output device.

25. The apparatus of claim 24, further comprising means for setting half-tone image pixels corresponding to the portion of input pixels that are above the threshold based on the dithering.

26. The apparatus of claim 24, wherein the means for dithering is configured to quantize the portion of the input pixels.

27. The apparatus of claim 26, wherein the means for dithering is further configured to diffuse a quantization error.

28. The apparatus of claim 27, wherein the means for dithering is further configured to diffuse at least a portion of the quantization error resulting from quantizing the portion of input pixels below the crush threshold to half-tone image pixels.

29. The apparatus of claim 27, further comprising means for clipping quantization error resulting from the quantizing before diffusing the quantization error.

30. The apparatus of claim 24, wherein the means for dithering is further configured to utilize Floyd Steinberg Error Diffusion.

31. The apparatus of claim 24, wherein the means for dithering is further configured to add noise to the input pixel.

32. The apparatus of claim 24, wherein the crush threshold is between four percent and six percent of a dynamic range of a plurality of input pixels.

33. The apparatus of claim 24, further comprising means for utilizing a second crush threshold for green pixels that is lower than the crush threshold, and wherein the crush threshold is used for non-green pixels.

34. A non-transitory, computer readable medium comprising instructions that when executed causes one or more processors to perform a method of rendering at least a portion of a half-tone image on a display, the method comprising:
receiving an input image including a plurality of input pixels;
dithering at least a portion of the input pixels;
setting half-tone image pixels corresponding to the portion of the input pixels that are below a crush threshold to a crushed value; and
outputting the half-tone image pixels to an output device.

35. The non-transitory, computer readable medium of claim 34, wherein the method further comprises setting half-tone image pixels corresponding to the portion of input pixels that are above the threshold based on the dithering.

36. The non-transitory, computer readable medium of claim 34, wherein dithering includes quantizing the portion of the input pixels.

37. The non-transitory, computer readable medium of claim 36, wherein dithering further includes diffusing a quantization error resulting from quantizing the input pixels.

38. The non-transitory, computer readable medium of claim 37, wherein at least a portion of the quantization error resulting from quantizing the portion of input pixels below the crush threshold is diffused to half-tone image pixels.

39. The non-transitory, computer readable medium of claim 34, wherein the dithering utilizes Floyd Steinberg Error Diffusion.

40. The non-transitory, computer readable medium of claim 34, wherein the dithering adds noise to the input pixel.

41. The non-transitory, computer readable medium of claim 34, wherein the crush threshold is between four percent and six percent of a dynamic range of a plurality of input pixels.

42. The non-transitory, computer readable medium of claim 34, wherein the method further includes utilizing a second crush threshold for green pixels that is lower than the crush threshold, wherein the crush threshold is used for non-green pixels.
